(19) United States
(12) Patent Application Publication
(10) Pub. No.: US 2026/0151948 A1
(43) Pub. Date: Jun. 4, 2026

(54) MULTI-LAYERED BIODEGRADABLE POLYMER NANOCOMPOSITE-BASED FILM

(71) Applicant: COUNCIL FOR SCIENTIFIC AND INDUSTRIAL RESEARCH, PRETORIA (ZA)

(72) Inventors: Jayita BANDYOPADHYAY, Pretoria (ZA); Orebotse Joseph BOTLHOKO, Pretoria (ZA); Raphaahle MEKOA, Pretoria (ZA); Rakgoshi LEKALAKALA, Midrand (ZA); Suprakas SINHA RAY, Pretoria (ZA)

(21) Appl. No.: 19/123,953

(22) PCT Filed: Oct. 27, 2023
(86) PCT No.: PCT/ZA2023/050070

§ 371 Date: Apr. 24, 2025

(30) Foreign Application Priority Data
Oct. 27, 2022 (ZA) 2022/11707

(51) Int. Cl. B29C 48/21; B29C 48/00; B29C 48/405; B29K 67/00; B29K 105/00; B29K 105/16; B29K 303/08; B29K 305/02

(52) U.S. Cl. CPC B29C 48/21; B29C 48/0018; B29C 48/405; B29C 2948/92552; B29C 2948/9258; B29C 2948/92704; B29K 2067/00; B29K 2105/0044; B29K 2105/162; B29K 2303/08; B29K 2305/02; B29K 2995/006; B29K 2995/0097

(57) ABSTRACT

The present invention provides a preparation method for biodegradable polymer nanocomposite films with superior gas barrier, tensile properties, and dimensional stability at the retort temperature utilizing a one-step-reactive compounding process to achieve improved interaction between a biodegradable polymer, which is an aliphatic-aromatic copolyester based on the monomers 1,4-butanediol, adipic acid, terephthalic acid, succinic acid, and lactic acid in the polymer chain, and nanoparticles, including layered silicate type nanoclay and Metal Organic Framework (MOF). Various biodegradable polymers, such as PBAT, PLA, PHA, PBS, PCL, and PHBV, can be used as the supportive outer layers in a nanocomposite multilayer films, providing versatility in applications. The one-step-reactive compounding method offers an economical and environmentally friendly approach for the preparation of these advanced biodegradable polymer nanocomposite films.

### FIELD OF INVENTION

The present invention relates to the development of biodegradable polymer nanocomposite films with superior gas barrier properties and dimensional stability and discloses a preparation method thereof.

### BACKGROUND OF THE INVENTION

The demand for sustainable food packaging is increasing with the boosting of meals-ready-to-eat in modern days. Light weight and high gas barrier properties of polymers make them attractive for food packaging. Conventional polymers such as polyethylene terephthalate (PET), ethylene vinyl alcohol (EVOH), polyamide (PA), polyethylene (PE), and polypropylene (PP) are widely used in food packaging because of their gas and aroma barrier alongside their mechanical properties and processability. However, a significant amount of such plastic packaging either ends up in the landfill (40%) or leaked into the eco system (32%).[1] Only 14% of such packaging is collected for recycling, and another 14% is incinerated. The development of biodegradable (including compostable and those undergoing hydrolytic degradation) packaging can provide a route to solve the land fill issue as the material can be degraded/composted after its end-use. However, poor gas barrier property, dimensional stability, and high cost (e.g., approximately four times more expensive than polyethylene) of the biodegradable polymer compared to conventional polymers hinder their applications in food packaging. Typical oxygen permeation and water vapor permeation through the plastic packaging depend on the type of food itself. The oxygen and water vapor barrier properties of the common biodegradable polymers like polylactic acid (PLA), polybutylene adipate terephthalate (PBAT), poly butylene succinate (PBS) is approximately more than a decade higher than the PET and PA6, used widely in packaging. Improvement in oxygen and water vapor barrier or other words, reduction in permeation rates of target molecules in biodegradable polymers, in this instance, PBAT at a comparable level to the conventional plastics can enable the industry to design high barrier sustainable packaging for the future market need.

The high-barrier films market for food packaging is expected to grow at a compound annual growth rate (CAGR) of 5.9% from 2021 to 2028 and reach USD 30.8 billion by 2028. The growing trend is attributed to the inclination towards meal ready-to-eat (MRE) packaging products, the rising need for longer shelf-life, growing consumer concerns for food wastage reduction, and growing demand from the meat industry.[2] Worldwide sales of MRE packaging are expected to increase by approximately 2.0 times in 2027 from 2019, estimated to be over USD 1,900 million in 2019.[3] In addition, the growing demand for high-barrier biodegradable packaging films is expected to create lucrative opportunities for barrier film manufacturers.[2]

Various strategies used to enhance the gas barrier properties of the polymeric materials include decreasing the absorption, solubility, diffusion, and desorption of the permeant through the material. Common Approaches to improve the gas barrier properties include tailoring the polymer architecture, controlling crystallization and orientation, blending different polymers, multi-layer co-extrusion, coating using different techniques like layer-by-layer deposition, chemical vapor deposition, and incorporation of fillers such as nanoclay, graphene oxide, cellulose nanocrystal, zinc oxide, zeolite, a combination of magnesium oxide with silver nanoparticles, nanosilica, titanium dioxide, silver oxide, etc.[4-14] WO2021/226722 A1 discloses that incorporation of 15% micron-sized miscanthus fiber biocarbon into poly(butylene succinate) (PBS) by melt blending enables a reduction in oxygen permeation by approximately 99.8% in 0.8 mm thick compression molded specimen when compared with the neat PBS.[15]U.S. Pat. No. 7,619,025 B2 relates to a composition that comprises poly(lactic acid) (PLA) or poly(hydroxy butyrate) (PHB), poly(butylene adipate-co-terephthalate) (PBAT), and a fatty acid triglyceride quaternary ammonium salt modified nanoclay to develop a high-barrier, biodegradable material for packaging.[16] The extruded pellets of the blends and composites were compression molded to form the films used to test the gas barrier properties. The authors have claimed that the oxygen barrier of molded PLLA/PBAT/Cloisite 25A (57/38/5) film is comparable to oriented polypropylene. The results show that approximately 78% reduction in the oxygen permeation can be achieved in PLLA/PBAT/Cloisite 25A (57/38/5) film with respect to the PBAT film and that in the case of PHB/PBAT/Cloisite 30B (66.5/28.5/5) is approximately 62.5%.

US 2012/0183779 A1 directed to providing a multilayer film with excellent adhesive strength between interfaces of two resins and no longer requiring a separate adhesive or tie layer by co-extruding aliphatic polycarbonate and co-polyester polymer.[17] Approximately 87.6% reduction in oxygen permeation can be obtained in the three-layered film of PBAT/PPC (polypropylene carbonate)/PBAT of layer thicknesses 75/45/75 when compared to PBAT film. Similarly, close to 91% reduction in oxygen permeation can be obtained in the three-layered film of PBAT/PPC/PBAT of layer thicknesses 60/50/60 μm compared to only PBAT film. Three-layer structure of film or sheet in which surface layers made of PBAT and laminated/coextruded on both surfaces of PPC. However, PPC has its challenge: relatively lower Vicat softening temperature and poor mechanical properties resulting from its ester molecular structure restrict its application. The material shrinks rapidly near the Vicat softening temperature.

CN 111234279B discloses a method of improving the water vapor barrier of PBAT-based film comprised of 0.5 to 10 wt % crosslinking agent such as triallyl isocyanurate, trimethylopropane trimethacrylate, and trimethylopropane triacrylate. Biaxial stretching and electron beam radiation were used to improve the water vapor barrier property of the respective film.[18] Metal organic frameworks (MOF) are well-known for their highly porous structure required for absorption and separation application. For instance, CN 110064311B imparts a multi-layer composite film preparation method with ionic liquid and MOF by layer-by-layer deposition method, and the respective membrane can separate hydrogen and carbon dioxide.[19] The absorptive characteristics of MOF can be beneficial for improving the gas barrier properties of the polymer nanocomposite-based article or film.

When nanoparticles are introduced in a polymer matrix, the key functions to be built in are improving matrix-filler interaction, controlling the flow property, crystallization, and dispersion. While adding compatibilizer/grafted polymer can improve the matrix filler interaction, chain extender and crosslinking agent can control the flow behavior. Nakayama et al. have reported that Joncryl improves the interaction between PLA and PBAT but weakens the hydrogen bonds between the silk chains caused by the reaction between the epoxy groups of Joncryl.[20] In our previous work, we have proposed simultaneous grafting of maleic anhydride (MA) onto polypropylene and subsequent reaction with aminosilane, which enables enhancement in the thermomechanical properties of polypropylene.[21] A Niemoeller has demonstrated a process of preparation of MA grafted PBAT. [22] The author used the supercritical graft copolymerization method, which is a viable alternative to polymer grafting in the melt or solution phase with either an azo-type or a peroxide-free radical initiator. Othman et al. have demonstrated the compatibilization of PP and bentonite in the presence of PP-g-MA.[23] Generally, peroxides are used during the grafting of MA onto the polymer. For instance, Saraphat et al. used LuperoX as the initiator to graft maleic anhydride onto PBAT.[24] In another context, U.S. Pat. No. 8,541,109 B2 relates to a biodegradable polyester, suitable for extrusion coating, comprising units deriving from at least a diacid and at least a diol, with long chain branches (isometric with respect to the main chains of the polyester) and alpha,alpha′-di (t-butylperoxy)diisopropylbenzene (LuperoXF).[25] It has similar viscosity, higher melt strength, higher breaking stretching ratio, lower neck-in, optimum adhesion to paper, excellent seal ability, and processability in extrusion coating systems. LuperoX is an organic peroxide and claimed the process of blending as a reactive extrusion. The reactively extruded samples exhibited a lowered melt viscosity which can be attributed to polymer chain scission and a reduced average molecular weight of the product due to elevated temperature and high shear melt processing in the presence of free radicals.

Another challenge with biodegradable polymers is the dependency of biodegradation on the thickness of the specimen. Indeed, literature have shown that the addition of nano-sized fillers can potentially confer multifunctional enabling properties to several polymers when compared to the neat resin. [26] Several studies have been reported on the preparation of PBAT/organoclay nanocomposites. Santosh et al. studied the effect of different types of organically modified nanoclays (C10A, C20A, and C30B) on the dispersion and hence the thermomechanical properties of PBAT. [27] No substantial improvement in dispersion and properties have been achieved in the presence of such nanoclays. Falcaõ et al. have observed more than 50% reduction in oxygen permeation in PBAT/C20A film containing 5 wt % C20A compounded in a Haake Rheomixer and later converted into film via a single screw extruder. [28] Authors also reported that while PBAT only degrades by 1% after 14 weeks of burial in the soil, it degrades significantly one week after being exposed to UV radiation (49 and 62% after 5- and 30-days UV exposure).

It is accordingly an objective of the invention to provide a biodegradable packaging material with superior gas barrier properties and dimensional stability that will meet the requirements of high-barrier sustainable packaging for the future market.

### SUMMARY OF THE INVENTION

According to the invention, a preparation method of biodegradable polymer nanocomposite films with superior gas barrier and tensile properties and dimensional stability at the retort temperature is provided, said preparation method include:
providing a biodegradable polymer;
providing nanoparticles, said particles including layered silicate type nanoclay;
providing nanoparticles, said particles including Metal Organic Frameworks (MOF);
wherein improved interaction between polymer and the nanoparticles and hence the dispersion and distribution of nanoparticles, responsible for such improvements, is attributed to a one-step-reactive compounding method.

Biodegradable polymer of choice may encompass aliphatic-aromatic copolyester based on the monomers 1.4-butanediol, adipic acid, terephthalic acid, succinic acid, and lactic acid in the polymer chain.

In one formulation, the biodegradable polymer used to prepare the nanocomposite disclosed herein is preferably biodegradable polyester like PBAT.

PBAT is an aliphatic-aromatic copolyester based on the monomers 1.4-butanediol, adipic acid and terephthalic acid in the polymer chain with commercial name of grade ecoflexF Blend C1200.

The nanoparticles may contain natural or synthetic nanoclay and with or without surface treatment or ion exchange modification and preferably from the layered silicate family and a metal organic framework (MOF) with high absorption capacity.

In one formulation, the nanoparticles include layered silicate type nanoclay, preferably in the pristine form.

In one formulation, the MOF having aluminium sulphate octadecahydrate (Al₂(SO₄)₃·18H₂O, 99%) with fumaric acid (C₄H₄O₄, 99%) being the organic linker.

The method as claimed above, wherein the concentration of nanoparticles can range between 1 to 10 wt %, preferably below 5 wt %.

In one formulation, wherein the concentration of nanoclay and MOF in the nanocomposite can be altered but preferably below 5 wt %.

In one embodiment of the present invention, the reactive compounding process may relate to an extrusion technique, preferably co-rotating twin screw extrusion of biodegradable polymer and nanofillers in the presence of free radical initiator like dicumyl peroxide (DCP), functional organic moiety like maleic anhydride (MA) to enhance wettability of nanoclay in the polymer matrix, and a chain extender like Joncryl ADR 4368 (tailored styrene-acrylic oligomer with epoxy functions) to minimise the reduction in molecular weight during processing. Preferably the reactive extrusion can take place in the presence of an antioxidant like Irganox B225 (mixture of two different antioxidants namely organic phosphite known as Irgafos® 168 and a hindered phenolic antioxidant known as Irganox® 1010).

In one formulation a free radical initiator may be provided in the form of a peroxide such as dicumyl peroxide in the range of 0.2 to 0.5 wt %, preferably 0.1 wt %.

In one formulation wherein the functional organic moiety may be maleic anhydride in the range of 1 to 6 wt % and preferably 1.9 wt %.

In one formulation the typical concentration of initiator, MA, chain extender, and the antioxidant are kept constant at 0.1 wt %, 1.9 wt %, 0.5 wt %, and 0.4 wt %, respectively.

In one method wherein said nanocomposites may be processed using a temperature profile 120113011401145113011201110111011101110° C., screw speed between 80 and 200 rpm preferably of 116 rpm, and feed rate of 1 to 15 kg per hour, preferably 6.6 kg/h.

In one formulation, wherein extrudate can be collected through water bath or air, preferably through air prior to palletisation. Pellets are subsequently dried at 70° C. for 16 h and used to prepare multi-layered nanocomposite films.

Uniform distribution of nanofillers may be achieved via simultaneous grafting of MA onto PBAT and subsequent reaction of MA with the nanoclay and the MOF during the one-step reactive extrusion.

One-step method is more economically viable and environment friendly approach. CO—O—CO bond of anhydride opens during grafting and forms hydrogen bonding with the OH present in the nanoclay and thus compatibilized between the nanoclay and PBAT. This restricts OH stretching vibration in the reactively processed nanocomposite when compared with the nanocomposite comprised of pristine nanoclay.

Compatibilization between polymer and the nanoclay improves dispersion and distribution of nanoclay in the nanocomposite which creates impermeable barrier to oxygen molecules and retards oxygen permeation by creating a tortuous path when integrated in the multi-layered film. However, such film cannot provide sufficient water vapor barrier unless high aspect ratio of nanoclay is maintained in the nanocomposites; smaller volume of water molecule than that of oxygen also affects the permeability properties.

Approximately 20-89% reduction in oxygen permeation may be achieved in the reactively processed nanocomposite film depending on the film constructions when compared with the comparative films with the neat polymers.

Not only oxygen barrier, the tensile properties and the dimensional stability at the retorting temperature also improve in the nanocompsite film where nanocomposite is prepared by reactive extrusion.

CO—O—CO bond of anhydride opens in a similar fashion in the reactively processed MOF nanocomposites and C═O of conjugated anhydride reacts with the OH bond bridging coordination of organic ligand with Al₄(OH)₂ in MOF, thus enhancing the compatibilization between PBAT and MOF. Uniform distribution of MOF in PBAT nanocomposite is achieved due to such matrix-filler interaction.

Film comprised of reactively processed MOF nanocomposite provides both oxygen and water vapor barrier by creating tortuous path and its inherent absorption characteristics. MOF has high surface area (744.9 m²/g, determined by BET) and the single point adsorption total pore volume of pores (0.47 cm³/g). A film comprised of reactively processed MOF nanocomposite also provides better tensile properties and the dimensional stability at the retorting temperature when compared with the comparative films with the neat polymers.

A film may be processed via the method as described above which contains reactively processed polymer nanocomposite for instance PBAT nanocomposite as a central layer and the biodegradable polymer of a specific choice as the supportive outer layers.

In another aspect of the invention, there is provided for a biodegradable polymer nanocomposite film as obtained from the method described herein above.

### BRIEF DESCRIPTION OF THE DRAWINGS

FIG. 1—shows the invention relates to the development of biodegradable polymer nanocomposite film with superior barrier properties and discloses a preparation method thereof;

FIG. 2—shows the cross-section of different multi-layered films; Film constructions 100, 200 and 400 are for comparative examples, film constructions 300, 320 and 330 comprises reactively processed nanocomposites with different concentration of nanoclay, construction 500 comprises reactively processed nanocomposites film with 2:1 layered silicate namely Eccafeed sodium bentonite nanoclay (EFD) [Nanocomposite is abbreviated as EFD rxn], film construction 600 comprises a reactively processed nanocomposites with 1:1 layered silicate namely kaolin [Nanocomposite is abbreviated as Kaolin rxn] as the central layer supported by EFD rxn and the outer PBAT layers, film construction 700 comprises nanonocomposite based on EFD but not reactively processed [Nanocomposite is abbreviated as EFD w/o rxn] and kaolin rxn as a central layer, film construction 800 comprises reactively processed nanocomposites with MOF [Nanocomposite is abbreviated as MOF rxn] as the central layers and film construction 900 comprises kaolin rxn as the central layer supported by MOF rxn and neat PBAT as outer layers. The sample identities corresponding to the constructions 400, 500, 600, 700, 800, and 900 are abbreviated as MV570, MV573, MV574, MV572, MV575, and MV576, respectively;

FIG. 3—shows the thermal stability of the nanocomposites: (a) effect of nanoclay concentration in the reactively processed nanocomposites and (b) effect of different types of nanoparticles;

FIG. 4—shows the scanning electron microscopy (SEM) images showing the distribution of EFD nanoclay in the anocomposites with varying EFD nanoclay concentration;

FIG. 5—shows the Fourier transformed infrared spectroscopy (FTIR) spectra showing characteristic molecular vibrations in the nanocomposites with varied EFD nanoclay loading;

FIG. 6—shows the FTIR spectra showing matrix-filler compabilization in the nanocomposites with varied EFD nanoclay concentration;

FIG. 7—shows the FTIR spectra showing characteristic molecular vibrations in the nanocomposites comprised of EFD and kaolin nanoclays, and MOF;

FIG. 8—shows the FTIR spectra showing matrix-filler compabilization in the nanocomposites comprised of different nanoparticles;

FIG. 9—shows the schematic diagram representing the matrix-filler interaction due to the reactive processing;

FIG. 10—shows the transmission electron microscopic (TEM) images indicating the distribution of the different nanoparticles in the nanocomposites;

FIG. 11—shows the water vapor transmission rates of the selected films over time: Central layers in MV570, MV573, and MV575 are PBAT, EFD rxn, and MOF rxn. Neat PBAT was used as the outer layers;

FIG. 12—shows the biodegradation characteristics of the microcrystalline cellulose and the multilayered films MV570, MV573, MV574, MV572, MV575, and MV576 within the incubation period of 180 days as measured by respirometer analysis under controlled composting conditions;

FIG. 13—shows the photographs of the disintegrated films;

FIG. 14—shows the SEM images of the surface of the disintegrated film segments at different intervals;

FIG. 15—shows the FTIR spectra of the disintegrated film segments of the film MV570;

FIG. 16—shows the FTIR spectra of the disintegrated film segments of the film MV573;

FIG. 17—shows the FTIR spectra of the disintegrated film segments of the film MV574;

FIG. 18—shows the FTIR spectra of the disintegrated film segments of the film MV572;

FIG. 19—shows the FTIR spectra of the disintegrated film segments of the film MV575;

FIG. 20—shows the FTIR spectra of the disintegrated film segments of the film MV576;

FIG. 21—shows the experimental (*.ift) and approximated (*.app) scattering curves before and after composting for 90 days;

FIG. 22—shows the pair-distance distribution functions in different films before and after composting for 90 days;

FIG. 23—shows the electron density functions obtained from the small angle X-ray scattering (SAXS) analysis in different films before and after composting for 90 days;

FIG. 24—shows the experimental scattering curves of MV575 and MV576 before and after composting for 90 days;

FIG. 25—shows the wide-angle X-ray scattering patterns for different films before and after composting for 90 days; and

FIG. 26—shows the biodegradation of the multi-layered films. (a) the compost-soil mixture, (b) plantation of seeds, (c, c′) seed germination and the representative plant growth in soil, (d, d′) in the soil used to compost cellulose, in the soil used to compost the films (e, e′) MV570, (f, f′) MV573, (g, g′) MV574, (h, h′) MV572, (i, i′) MV575, and (j, j′) MV576.

### DETAILED DESCRIPTION OF THE DRAWINGS

This invention describes a preparation method for biodegradable polymer nanocomposite films with superior gas barrier properties, tensile properties, and dimensional stability. This entails a one-step-reactive compounding, preferably a twin-screw extrusion process related to the biodegradable polymer-based nanocomposite preparation and integration of the nanocomposite in the multi-layered film structure. The biodegradable polymer of choice can encompass aliphatic-aromatic co-polyester based on the monomers 1.4-butanediol, adipic acid, terephthalic acid, succinic acid, and lactic acid in the polymer chain. Preferred nanoparticles are layered silicate-type nanoclays and MOFs with a high aspect ratio, which can create a tortuous path and/or has a high surface area and pore volume available for sorption of gas molecules.

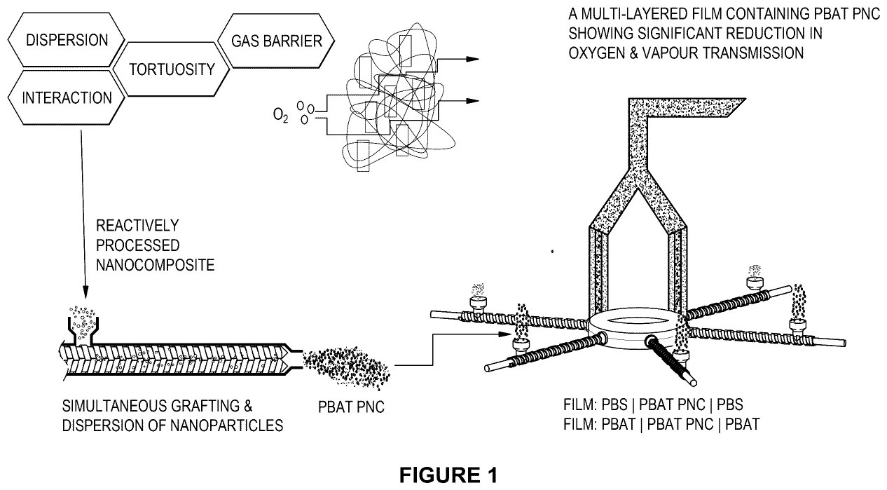

FIG. 1 illustrates the strategies taken for developing biodegradable polymer nanocomposite film with superior barrier properties. As used herein, reactive processing, a method of simultaneous grafting of functional moiety and nanoparticles that ameliorates the dispersion and distribution of nanoparticles in the biodegradable polymer matrix, is disclosed. Subsequently, in the example films, nanocomposites form the central barrier layer in the multi-layered biodegradable polymer film, and the neat polymers are used as support/outer layers. Comparative example films are composed of neat polymers such as polybutylene adipate-co-terephthalate (PBAT), polybutylene succinate (PBS), or a combination of neat polymer, and MA grafted PBAT (PBAT-g-MA).

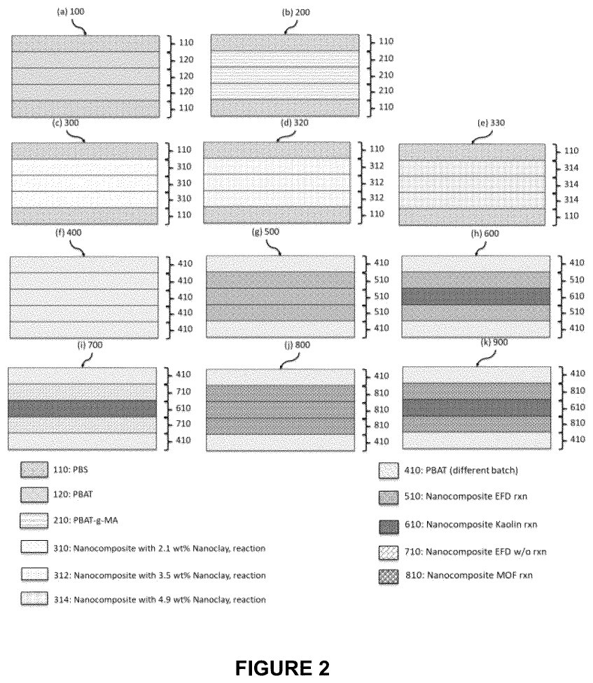

FIG. 2 shows the cross-section of different multi-layered films. FIG. 2a shows a comparative example 1 100 composed of neat PBS 110 as outer layers and neat PBAT 120 as the central layers.

FIG. 2b shows a comparative example 2 200 composed of neat PBS 110 as outer layers and PBAT-g-MA 210 as the central layers.

FIG. 2c shows example 1 300 composed of neat PBS 110 as outer layers and reactively processed 2.1 wt % nanoclay-containing nanocomposite 310 as the central layers.

FIG. 2d shows example 2 320 composed of neat PBS 110 as outer layers and reactively processed 3.5 wt % nanoclay-containing nanocomposite 312 as the central layers.

FIG. 2e shows example 3 330 composed of neat PBS 110 as outer layers and reactively processed 4.9 wt % nanoclay-containing nanocomposite 314 as the central layers.

FIG. 2f shows a comparative example 3 400 composed of only neat PBAT 410.

FIG. 2g shows example 4 500 composed of neat PBAT 410 as outer layers and EFD nanoclay-containing nanocomposite prepared via reactive extrusion 510 as the central layers.

FIG. 2h shows example 5 600 composed of neat PBAT 410 as outer layers, reactively processed kaolin nanoclay-containing nanocomposite 610 as the core, and reactively processed EFD nanoclay-containing nanocomposite 510 sandwiched between the core and the outer layers.

FIG. 2i shows example 6 700 composed of neat PBAT 410 as outer layers, reactively processed kaolin nanoclay-containing nanocomposite 610 as the core, and EFD nanoclay-containing nanocomposite prepared without reaction 710 sandwiched between the core and the outer layers.

FIG. 2j shows example 7 800 composed of neat PBAT 410 as outer layers, and reactively processed MOF-containing nanocomposite 810 as the central layers.

FIG. 2k shows example 8 900 composed of neat PBAT 410 as outer layers, reactively processed kaolin nanoclay-containing nanocomposite 610 as the core, and reactively processed MOF-containing nanocomposite 810 sandwiched between the core and the outer layers.

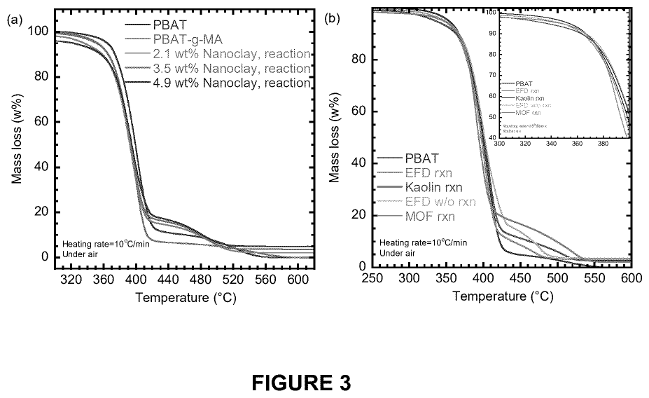

Inorganic content in the nanocomposites is determined by thermogravimetric analysis (TGA); the results are presented in FIG. 3. The thermal stability of the nanocomposites follows the same trend as the neat PBAT. The thermal stability of PBAT decreases slightly in PBAT-g-MA and marginally in the nanocomposites. The free radical initiator used during reactive processing under heat and shear might lead to polymer chain scission, which reduced the thermal stability in PBAT-g-MA and the nanocomposites. Inorganic contents in the reactively processed nanocomposites 310, 312, 314, 510, 610, and 810 are approximately 2.1, 3.5, 4.9, 5.4, 5.0, and 2.5 wt %, respectively, and that in the nanocomposite without reaction 710 is 3.4 wt %.

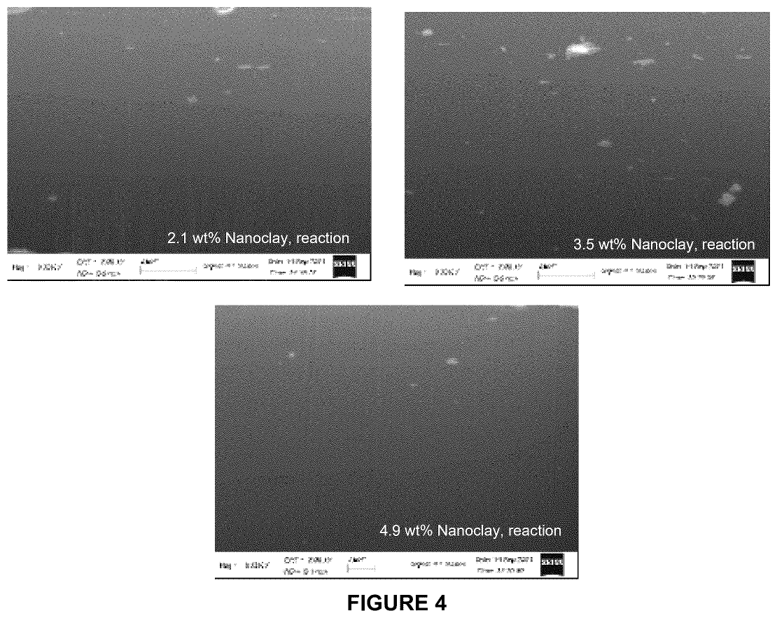

The dispersion characteristics of nanoclay in the reactively processed nanocomposites 310, 312, 314 with varied concentrations of nanoclay are studied by scanning electron microscopy (SEM, Zeiss Auriga CrossBeam FIB Workstation with GEMINI FESEM Column) and presented in FIG. 4. The white entities in FIG. 4 represent the dispersed nanoclay in the different nanocomposites. It is evident from the figure the distribution of nanoclay improves in the nanocomposite containing 3.5 wt % nanoclay 312 when compared with the nanocomposite containing 2.1 wt % nanoclay 310. Only a few stackings of nanoclay are visible in the nanocomposite containing 4.9 wt % nanoclay 314, probably due to the agglomerated structures of the nanoclay at higher loading.

Typical properties of the reactively processed nanocomposites 310, 312, and 314 with varied concentrations of nanoclay are summarized in Table 1. The crystallization peak temperature (T_{c}), enthalpy of crystallization (ΔH_{c}), glass transition (T_{g}), melting peak temperature (Tₘ), enthalpy of fusion (ΔH_{f}) of the nanocomposites are determined by differential scanning calorimetry (DSC, Model Q2000 from TA Instruments, USA). The samples were heated from −70° C. to 190° C. at a rate of 10° C./min, cooled down at the same rate to −70° C. and reheated. It is evident from Table 1 that T_{c} of neat PBAT shifts towards the higher temperature, and ΔH_{c} decreases slightly after grafting of MA functional moiety onto the PBAT. Free radical formation and the subsequent grafting of MA facilitate nucleation but hinders the crystal growth mechanism. It also allows the shifting of T_{g} at a higher temperature in PBAT-g-MA 210 than in the neat PBAT. At lower concentrations, nanoclay retards the nucleation process and the crystal growth behavior 310, 312, but at a higher loading of nanoclay the nanocomposite 314 exhibits similar properties as the neat PBAT. Tₘ increases in PBAT-g-MA when compared with the neat PBAT and then decreases slightly in the presence of nanoclay. An increase in nanoclay concentration does not have a significant effect on Tₘ. Higher Tₘ in PBAT-g-MA 210 indicates grafting of MA and polymer chain extension to a certain extent. ΔH_{f} of all the samples appears approximately in a similar range.

Properties of the PBAT vary from batch to batch 410 and hence are reported accordingly in Table 2. A significant increase in T_{c} is observed in the nanocomposite comprised of EFD nanoclay irrespective of the processing method employed 510, 710. Nanocomposite comprised of kaolin nanoclay 610 also shows a similar trend. Reactively processed MOF nanocomposite 810 shows the highest nucleation effect and hence the highest T_{c}. ΔH_{c} marginally reduces in the nanocomposites processed without 710 and with 510 reactive processing; those contain EFD nanoclay, kaolin nanocomposite 610, and in the reactively processed MOF nanocomposite 810. T_{g} of the neat polymer remains unaltered in the nanoclay containing nanocomposites 510, 610, and 710. Shifting of T_{g} towards lower temperature in the reactively processed MOF nanocomposite 810 indicates the segmental chain mobility increases the same in the presence of the nanofillers. Tₘ and ΔH_{f} of the nanocomposites appear in a similar range.

Extent of MA grafting was determined by the titration method, and as evident from Table 1, it decreases with the increase in the nanoclay concentration in the nanocomaposites. The melt flow rate (MFR) indicates the flow behavior changes after MA grafting onto PBAT 210 and then in the nanocomposites with different loadings of nanoclay 310, 312, 314. Approximately 10.5% reduction in MFR in PBAT-g-MA 210 also indicates the grafting of MA and polymer chain extension to a certain extent. Comparatively high MFR in the nanocomposites 310, 312, and 314 can be attributed to the polymer chain scission during the reactive processing, as supported by the TGA results. It is evident from Table 2 that irrespective of the processing method and the type of the nanoparticles, the MFR of the nanocomposites 510, 610, 710, and 810 increases when compared with the matrix.

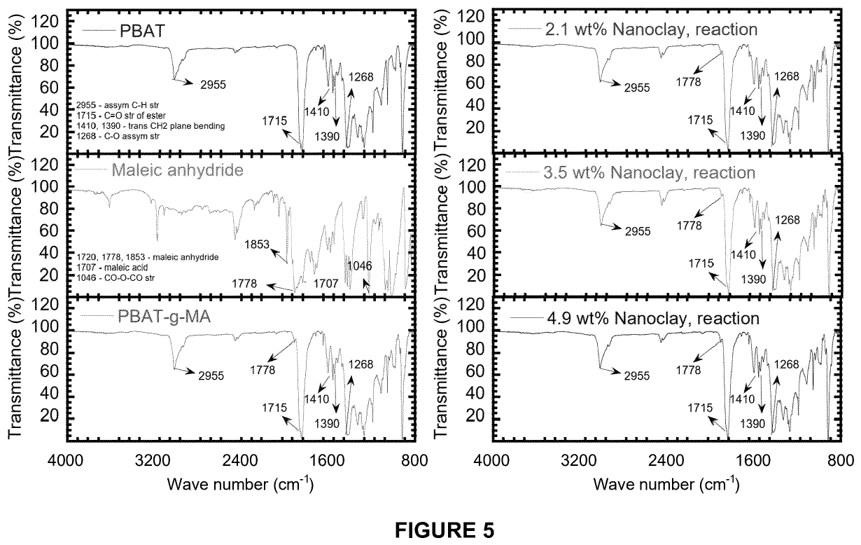

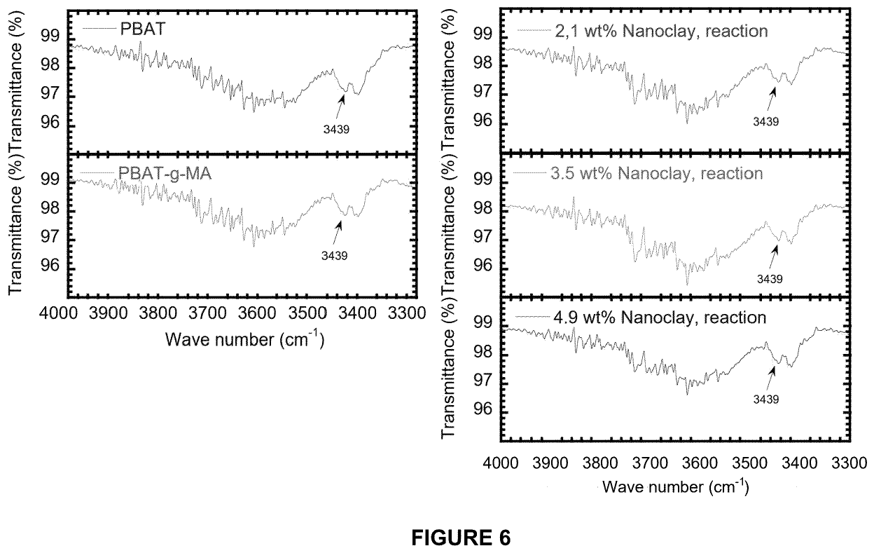

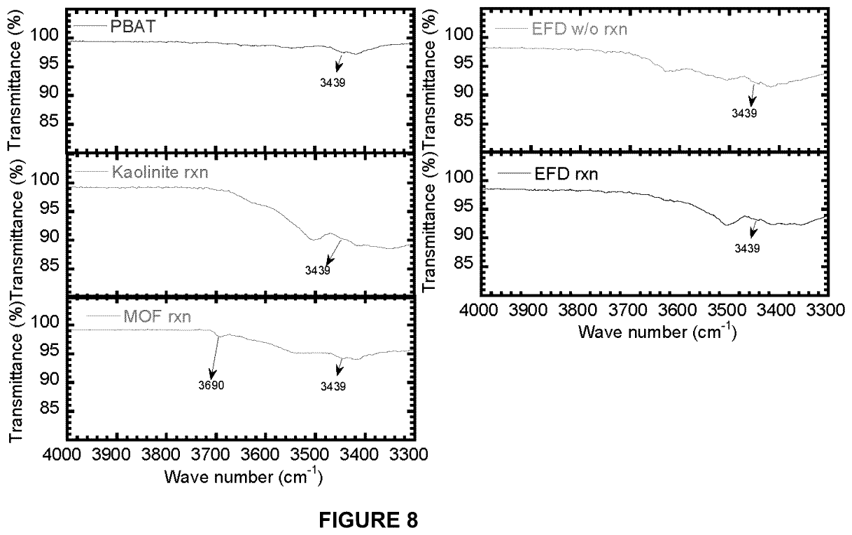

Fourier transformed infrared spectroscopy investigates reaction mechanism and the changes in the molecular bonds (FTIR, Model Spectrum 100, Perkin Elmer), and the results are presented in FIGS. 5-8. FIG. 5 shows that characteristic asymmetric C—H stretching, C═O stretching of ester, and C—O asymmetric stretching peaks of neat PBAT appear respectively at 2955, 1715, and 1268 cm⁻¹. In contrast, trans-CH2 in-plane peaks appear at 1410 and 1390 cm⁻¹. CO—O—CO stretching, C═O of maleic acid in the MA appear at 1046 and 1707 cm⁻¹, respectively. C═O stretching of conjugate anhydride peaks appeared in 1720, 1778, and 1853 cm⁻¹. OH bond vibration of PBAT is shown clearly in FIGS. 6 and 8. Characteristic vibrational bands of PBAT remain unaltered in the PBAT-g-MA. CO—O—CO stretching of MA is absent in PBAT-g-MA 210. However, the presence of C═O stretching of conjugate anhydride (1778 cm⁻¹) confirms the addition of functional groups onto the PBAT chains. Intensity OH bond vibration at 3439 cm⁻¹ reduces after grafting reaction, probably due to hydrogen bonding between MA counterparts and the OH in the polymer chain.

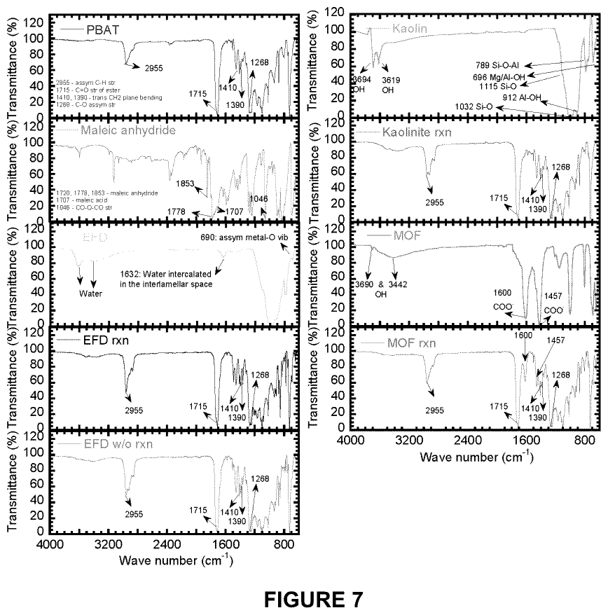

Characteristics bond vibrations of EFD nanoclay around 3600 and 3439 cm⁻¹ represent OH, while one at 1632 cm⁻¹ is due to the water intercalated in the interlamellar space (refer to FIG. 7). Asymmetric metal-O vibration occurs at 690 cm⁻¹. It is evident from FIGS. 5-8 that during reactive processing CO—O—CO bond of anhydride opens and forms hydrogen bonding with the OH present in the nanoclay and thus compatibilized between the nanoclay and PBAT. This restricts OH stretching vibration in the reactively processed nanocomposite 510 compared to the nanocomposite comprised of pristine nanoclay 710. As a result, it is observed in FIG. 8, OH vibration slightly diminishes in the nanocomposite prepared with reactive processing.

FIG. 7 shows that the characteristics of OH bond vibrations of kaolin nanoclay appear around 3694 and 3619 cm⁻¹. Si—O—Al, Mg/Al—OH, Si—O, Al—OH bands appear at 789, 696, 1115, and 912 cm⁻¹. However, the reactively processed nanocomposite comprised of kaolin 610 shows similar bond vibrations as observed in the reactively processed EFD nanoclay-based nanocomposite 510.

FIG. 7 shows that OH bond bridging coordination of organic ligand with Al₄(OH)₂ in MOF appears at 3690 and 3442 cm⁻¹. COO⁻ of organic ligand appears at 1600 and 1457 cm⁻¹. The presence of vibrations associated with COO⁻ and absence of 3442 cm⁻¹ indicate that the CO—O—CO bond of anhydride opens in a similar fashion in the reactively processed MOF nanocomposites 810 and C═O of conjugated anhydride reacts with the OH bond bridging coordination of organic ligand with Al₄(OH)₂ in MOF, thus enhancing the compatibilization between PBAT and MOF.

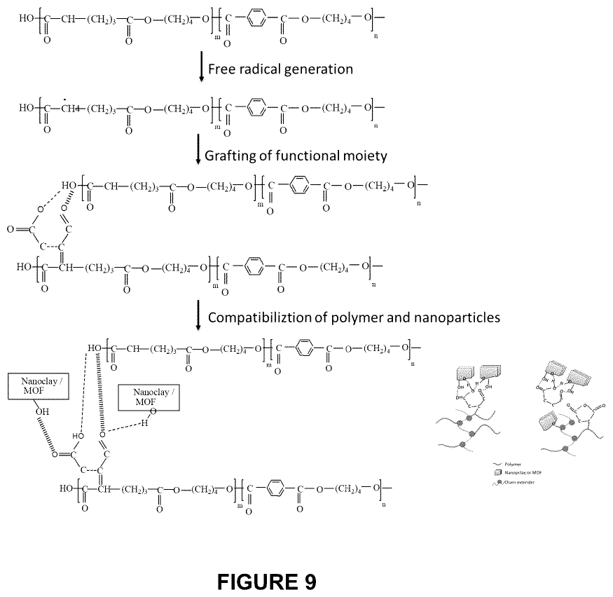

Based on the above discussion, the structures of PBAT-g-MA, nanoclay containing nanocomposites, and the MOF nanocomposite are proposed and presented in FIG. 9. The formation of functional moiety and chain extension might have occurred in PBAT-g-MA 210 and the nanocomposites, but a more pronounced effect is seen in PBAT-g-MA 210. Simultaneous grafting and the dispersion of nanoparticles in one-step enhances compatibilization between PBAT and the nanoparticles, resulting in uniform dispersion and distribution of nanoparticles in the polymer matrix.

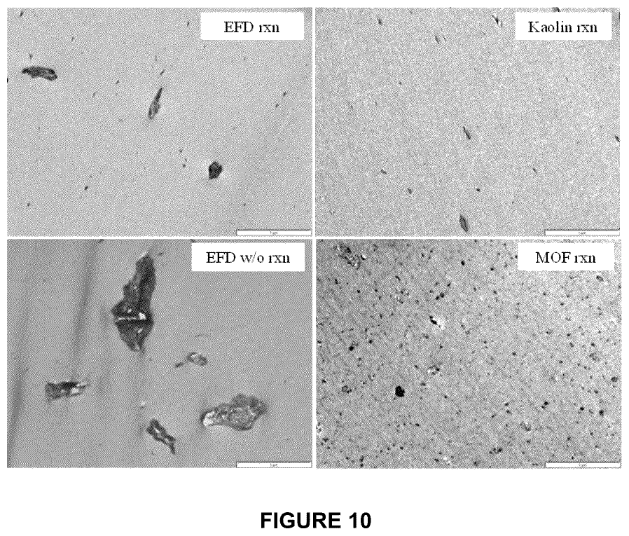

FIG. 10 shows the transmission electron microscopic (TEM) images of the nanoclay-based nanocomposites prepared without and with reactive processing and the MOF nanocomposite. Samples were exposed to osmium tetroxide vapor overnight before the TEM sample preparation. Each sample was cryo-sectioned at −100° C. using a Leica UFC7 microtome. For TEM, sections were collected on copper grids and imaged at room temperature using a JEOL 1010 transmission electron microscope. The black entities represent the dispersed nanoparticles in the PBAT matrix. It is evinced from the figure that the dispersion and distribution of nanoclay improve in the reactively processed nanocomposite comprised of EFD nanoclay 510 when compared with the nanocomposite prepared without reactive processing 710. Kaolin and MOF are also well-distributed in the respective nanocomposites 710 and 810.

In a subsequent process, multilayered biodegradable polymer films are produced either with the neat polymers for comparative examples or a combination of neat polymer and the nanocomposite layers in the disclosed example films. Multilayered films can be prepared using any state-of-the-art film processing technique. Films described herein are produced using a five-layer coextruded film blower (Lab Tech Engineering Company Ltd, Thailand). The typical film processing temperature is 150° C. and a screw speed of 50 rpm. Referral film codes, and typical layer constructions of the multilayered films are tabulated in Table 3.

Oxtran determines the oxygen transmission rate of the films at 23° C. and 0% RH. The film surface area tested is 50 cm2. The results are summarized in Table 3.

The dimensional stability of the films is tested at the retort conditions (at 120° C. for 15 minutes) following ASTM D1204; the results are summarized in Table 3.

Tensile properties of the films are tested in both machine and transverse directions using Instron tensile tester (Model Instron 5966) equipped with load cell 10 kN. The crosshead speed and the gauge length used are 20 mm/min and 25 mm, respectively. The results are summarized in Table 4. Dimensions of the films tested are 20 mm×100 mm.

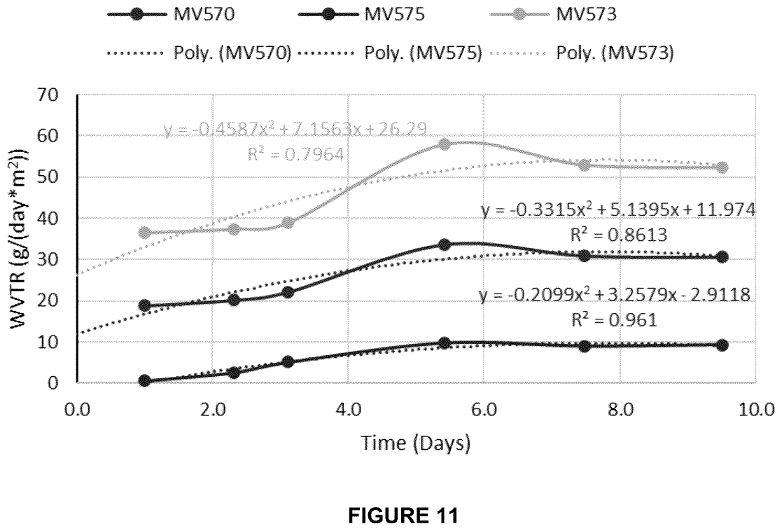

Water vapor transmission rate is studied following ASTM E 96 using a vapometer cup assembled in-house. The cups are filled with calcium chloride (CaCl₂)), covered with the test films, and placed in a humidity chamber at a set temperature of 23° C. and humidity condition (50% RH). The sample holders are removed from the chamber and weighed after certain intervals to determine the water vapor transmission rate. The water vapor transmission through different films as a function of time is presented in FIG. 11.

CO₂ evolution measurement of test samples and microcrystalline cellulose (positive reference) were studied in three replicates under controlled composting conditions at 58-60° C. using an Echo Automated respirometer system with CO₂/CH₄/O₂ sensors (ASTM D6400 & ASTM D5338 for disintegration test and respirometry CO₂ evolution test (mineralization)). A well aerated 3-month-old organic rich compost was used for this compost biodegradation study obtained from GardenMaster Compost, Pretoria, South Africa. The compost was passed through a sieve with a mesh of <0.8 cm to achieve a uniform particle size for the biodegradation study. Total dry solids obtained by taking a known volume of compost and drying at about 105° C. for 10 h was 48%. The amount of volatile solids obtained by subtracting the residue of a known volume of compost after incineration at about 550° C. for 30 min was 33%. pH of the compost solution was 7.5. Total organic carbon content, total nitrogen and carbon/nitrogen ratio determined by elemental analysis were 15.15%, 0.5% and 30.3%, respectively. The ultimate biodegradability (CO₂ evolution) of test samples films was tested under composting conditions alongside microcrystalline cellulose as a positive reference in three replicates as per ASTM D5338 method. 2 liters glass bioreactors were used for this biodegradation studies. Each reactor was filled with compost and test samples in the ratio of 6:1 (w/w based on dry mass). To mimic the aerobic biodegradation conditions, aeration of 500 ml/min was supplied to the reactors. The respirometer measures the evolved CO₂ emission, which is then used to calculate the biodegradation rate for each sample against the incubation period. The total CO₂ emitted from each reactor during the test conditions was considered the total degradation of the test sample. The biodegradation of the test sample was calculated based on the total organic carbon present in the test samples as determined by elemental analysis. Equation 1 below was used to calculate the theoretical CO₂ (CO₂(t)) in the total dry weight of plastic material.

$${CO}_{2} ( t ) = {M}_{t} \times {C}_{t} \times \frac{44}{12} \qquad ( 1 )$$

Mₜ and Cₜ represent, respectively, the total dry weight of plastic material added to the compost and the relative weight of the total organic carbon in the dry plastic material. The percentage biodegradation of the test sample's organic carbon mineralized as CO₂ was calculated according to the equation 2, where (CO₂)ₛ is the carbon dioxide from the test sample (compost+specimen), (CO₂)_{c} is the carbon dioxide from the blank compost, and (CO₂)ₜ is the total theoretical amount of carbon dioxide in the test material. A biodegradation curve was obtained by plotting percentage biodegradation versus incubation time.

$$Biodegradation ( \% ) = \frac{( C {O}_{2} ) s - ( C {O}_{2} ) c}{( {CO}_{2} ) t} \times 100 \qquad ( 2 )$$

The average of cumulative CO₂ evolved from compost inoculum under industrial composting conditions on days 1, 3, 5, 8, and 10 are respectively 404.8±0.9, 686.4±1.1, 783.2±2.0, 1724.8±1.0 and 2050.4±2.1 mg. After 10 days the average cumulative CO₂ emission was calculated based on volatile solids per gram of compost. The industrial compost inoculum experimental results showed 62.1 mg/g of volatile solids. According to the ASTM D5338 standard, the composting inoculum should produce between 50-150 mg of CO₂ per gram of volatile solids over the first ten days of the test, and therefore, the present study compost inoculum meets the standard requirements.

Disintegration testing is a primary degradation step to monitor whether the material breaks into small pieces. According to ASTM D6400, EN13432, and ISO 17088 specifications, a plastic product is considered to have demonstrated satisfactory disintegration if, after twelve weeks in a controlled composting test, no more than 10% of its original dry weight remains after sieving on a 2.0 mm sieve. Disintegration study of test samples was conducted under controlled composting conditions at 58-60° C. The samples (2 cm×2 cm films) were kept on the surface of the compost and tested periodically to investigate the disintegration mechanism.

After of the biodegradation respiration experiments, 5 g of compost from each reactor were mixed with 5 g of fresh agricultural soil, and five tomato seeds were planted. The pH of the compost-soil mixture was determined, and the results were between 7.2-7.4. Water was added to maintain the relative humidity of the compost-soil mixture to between 50-55%. This experiment was carried out in three replicates.

The dispersion and distribution characteristics of nanofillers in the multi-layered films, as well as change in crystallinity before and after biodegradation, were investigated by small- and wide-angle X-ray scattering (SWAXS). SWAXS experiments were performed using an Anton Paar SAXSess instrument (Anton Paar, Austria), operated at 40 kV and 50 mA. The instrument used CuKₐ radiation of wavelength 0.1542 nm (PAN Analytical X-ray source). Intensity profiles were obtained with a line-collimated SAXSess instrument and recorded with a two-dimensional imaging plate. The sample-to-detector distance was 261.2 mm, covering the scattering vector (q) length from 0.09 to 28 nm⁻¹. The read-out angles were calculated from the pixel size, and the obtained q-scale was cross-checked by measuring silver behenate, the equidistant peak positions of which are known. SWAXS data were collected at room temperature (20.6° C.), and all the samples were exposed to X-rays for 15 min.

The film described in the comparative example 1 100 is composed of neat PBS 110 as outer layers and neat PBAT 120 as the central layers. The oxygen transmission rate of this film is 850.1 cc/m²/day (refer to Table 3). The dimensional stability measured in machine and transverse directions are respectively 2.7% and 0.3%; the negative sign represents the shrinkage of the films. Tensile modulus, load at yield, ultimate tensile stress (UTS), and the elongation at break (refer to Table 4) of the said film in the machine direction are respectively 320.0±15.1 MPa, 53.2±3.1 N, 23.3±1.2 MPa, and 408.2±68.4% and those in the transverse direction are respectively 363.5±6.5 MPa, 53.1±1.7 N, 21.3±0.6 MPa, and 123.0±58.0%.

The film described in the comparative example 2 200 is composed of neat PBS 110 as outer layers and PBAT-g-MA 210 as the central layers. The oxygen transmission rate of this film is 1145.6 cc/m²/day (refer to Table 3). The increase in the oxygen transmission rate can be attributed mainly to the change in the polymer chain conformation in the central layers. The dimensional stability measured in machine and transverse directions are respectively 8% and 0%; the negative sign represents the shrinkage of the films. Tensile modulus, load at yield, ultimate tensile stress (UTS), and the elongation at break (refer to Table 4) of the said film in the machine direction are respectively 265.6±28.8 MPa, 44.0±5.2 N, 24.7±2.5 MPa, and 515.9±84.3% and those in the transverse direction are respectively 330.8±16.9 MPa, 47.5±4.6 N, 21.3±1.0 MPa, and 465.4±177.1%. Reduction in tensile modulus indicates the stiffness reduces, possibly due to the overall reduction in crystallinity as observed from the trend of ΔH_{c}. However, PBAT-g-MA 210 improves the flexibility of the film in both directions as there is a significant increase in the elongation at break when compared with the comparative example 1.

The film described in example 1 300 is composed of neat PBS 110 as outer layers and reactively processed 2.1 wt % nanoclay-containing nanocomposite 310 as the central layers. The oxygen transmission rate of this film is 93.8 cc/m²/day (refer to Table 3). Approximately 89% reduction in oxygen transmission rate is achieved in example 1 when compared with the comparative example 1. The reduction in the oxygen transmission rate is attributed to the matrix-filler interaction achieved via reactive processing of the nanocomposite 310, which eventually leads to the uniform dispersion and distribution of nanoclay in the said nanocomposite. The dimensional stability measured in machine and transverse directions are 3% and 0% respectively, like the comparative example 1. A negative sign represents the shrinkage of the films. Tensile modulus, load at yield, ultimate tensile stress (UTS), and the elongation at break (refer to Table 4) of the said film in the machine direction are respectively 251.3±17.6 MPa, 46.4±1.6 N, 19.7±1 MPa, and 390.2±81.2% and those in the transverse direction are respectively 267.6±14.6 MPa, 41.0±4.2 N, 18.5±2.0 MPa, and 466.3±132.2%. Reduction in tensile modulus indicates the stiffness reduces, possibly due to the overall reduction in crystallinity as observed from the trend of ΔH_{c}. However, the nanocomposite 310 improves the flexibility of the film in transverse directions as there is a significant increase in the elongation at break when compared with the comparative example 1.

The film described in example 2 320 is composed of neat PBS 110 as outer layers and reactively processed 3.5 wt % nanoclay-containing nanocomposite 312 as the central layers. The oxygen transmission rate of this film is 92.4 cc/m²/day (refer to Table 3). Approximately 89% reduction in oxygen transmission rate is achieved in the example 2 when compared with the comparative example 1. The reduction in the oxygen transmission rate is attributed to the matrix-filler interaction achieved via reactive processing of the nanocomposite 312, which eventually leads to the uniform dispersion and distribution of nanoclay in the said nanocomposite. The dimensional stability measured in machine and transverse directions are 1.3% and 0%, respectively. Therefore, the film disclosed here is approximately 50% more stable at the retort condition than the comparative example 1. A negative sign represents the shrinkage of the films. Tensile modulus, load at yield, ultimate tensile stress (UTS), and the elongation at break 068 (refer to Table 4) of the said film in the machine direction are respectively 245.8±42.6 MPa, 44.0±7.4 N, 18.5±3.6 MPa, and 425.1±63.2% and those in the transverse direction are respectively 263.1±3.3 MPa, 35.7±1.1 N, 15.8±1.4 MPa, and 331.6±109.0%. The film loses its tensile properties with the increase in the nanoclay concentration in the nanoclay-based nanocomposite 320 used as the central layers.

The film described in example 3 330 is composed of neat PBS 110 as outer layers and reactively processed 4.9 wt % nanoclay-containing nanocomposite 314 as the central layers. Further, increase in nanoclay concentration in the nanoclay-based nanocomposite 314 leads to the deterioration in all the film properties disclosed in example 3 330.

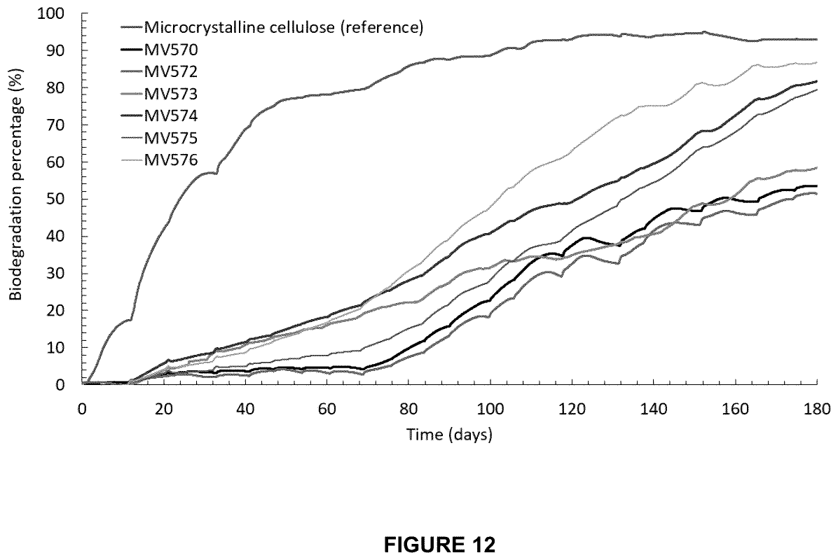

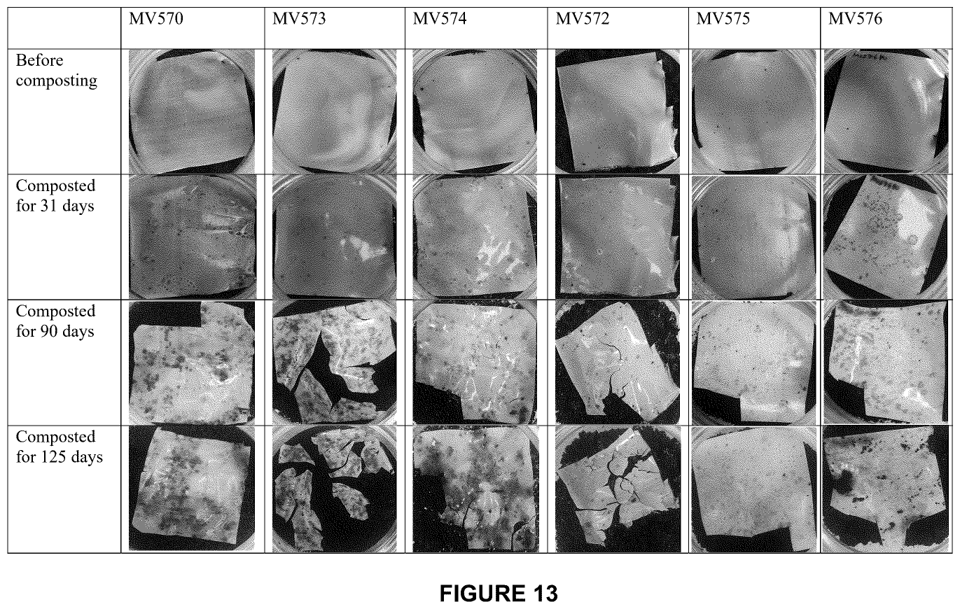

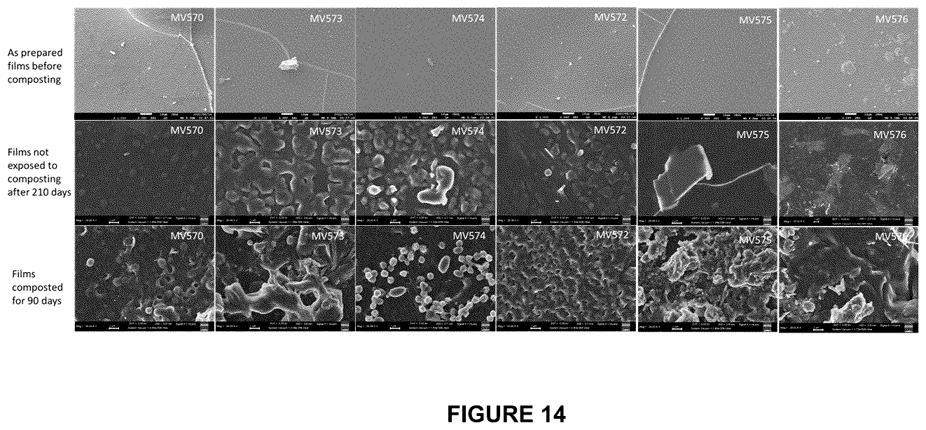

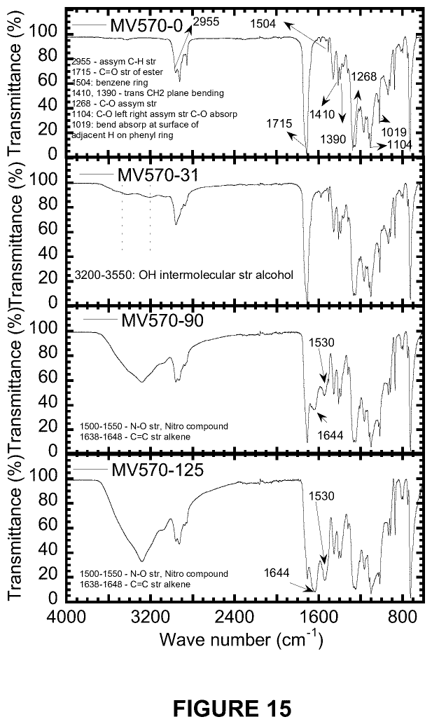

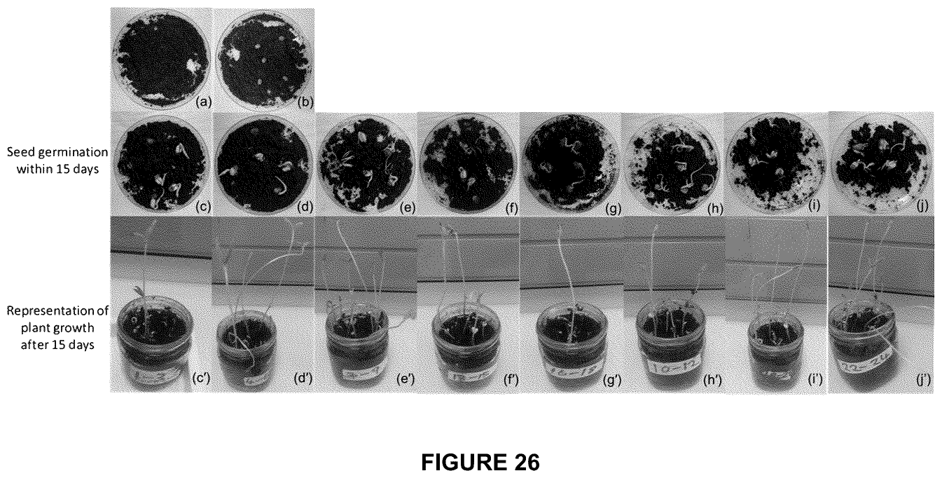

The film described in the comparative example 3 400 is composed of only neat PBAT (sample ID MV570) 410. The oxygen transmission rate of this film is 449.5 cc/m²/day (refer to Table 3). The dimensional stability measured in machine and transverse directions are respectively 6% and 2%; the negative sign represents the shrinkage of the films (refer to Table 3). Tensile modulus, load at yield, ultimate tensile stress (UTS), and the elongation at break (refer to Table 4) of the said film in the machine direction are respectively 91.1±12.3 MPa, 33.5±2.4 N, 13.9±1.0 MPa, and 489.8±94.1% and those in the transverse direction are respectively 73.3±14.9 MPa, 26.4±3.8 N, 11.1±1.6 MPa, and 467.8±117.6%. The amount of CO₂ to be released from the mass of the samples tested was estimated theoretically and used to determine the extent of biodegradation (mineralization), as presented in Table 5. The mass of the films tested was approximately 25 g, and that for the microcrystalline cellulose was 25 g. FIG. 12 shows the biodegradation characteristics of the cellulose and the multilayered films within the incubation period of 180 days as measured by respirometer analysis under controlled composting conditions. While cellulose attains 18% degradation within the first 15 days, no appreciable biodegradation is observed for the multilayered films. During this period, incubation takes place where microorganisms acclimatize to composting conditions. Microcrystalline cellulose shows more than 70% biodegradation within 45 days. This indicates that the biodegradation setup adopted meets the validity of test method requirements according to the ASTM D5338. The cellulose shows 90% degradation after 80 days and afterward exhibits a plateau phase as expected, while MV570 film degrades 4% in the first 70 days and reaches 53% at the end of 180 days. PBAT is commercially sold as fully biodegradable. However, the biodegradation of PBAT significantly depends on the form (powder or plaque or film) as well as the thickness of the specimens tested. For instance, fine milled particles of PBAT with an average size 100 μm can exhibit 88% degradation in the industrial composting conditions as used in this study.[29] In comparison, a PBAT film (thickness of 100 μm) attains approximately 50% degradation at the end of 120 days in the industrial composting condition. [30]A compression molded plaque of PBAT (1 mm thick) degrades <5%.[31] Not only the sample size, but the biodegradation of PBAT also depends on the type of compost. Kijchavengkul et al. reported that total biodegradation of PBAT film (thickness 38.1±5.1 μm) in manure, food, and yard compost is 67.3%, 44.9% and 33.9%, respectively, in 45 days. [32] A PBAT-blown film of thickness of approximately 70 μm can attain 80% biodegradation in 180 days. [33] Therefore, the film MV570 (approximately 120 μm thick) follows a similar trend as observed by Sere et al. Moreover, an aged PBAT film degrades approximately 18% after 182 days. [34] Mohanty and Nayak found that incorporating Cloisite 30B nanoclay (3 wt %) does not hinder the biodegradation of neat PBAT. Falcao et al. studied the effect of UV-irradiation on the biodegradability of the PBAT composites comprised of 1 and 5 wt % Cloisite 20A nanoclay. [28] Authors have found that a longer aging time (30 days) results in pronounced mass loss within a shorter period of biodegradation testing. Moreover, the biodegradation retards at a higher concentration of Cloisite 20A nanoclay. Ester bond in PBAT is susceptible to hydrolysis and leads to random main chain scission and rapid molecular weight reduction. [35] FIG. 12 indicates that primary degradation occurs during the first 70 days, where the long-chain polymeric molecules break into shorter chains by surface erosion. During surface erosion, microorganisms start consuming polymer enzymatically, causing an early slow reduction in molecular weight. [29] Subsequently, during the bulk erosion, the polymer starts to degrade throughout its cross-section by hydrolysis, and the low molecular weight fragments are assimilated to yield CO₂. The crystalline and amorphous regions and conformational flexibility (i.e., ease of bond rotation, moving atoms closer or further away from others) play an important role in controlling the hydrolysis. The factors affecting conformational flexibility are bulky side groups and certain linkages on the polymer backbone. The bulky side group limits polymer chain movement and reduces flexibility. In contrast, certain linkages on the polymer backbone, like carbon double bond, increases flexibility by easing rotation around the adjacent bond. In a semicrystalline polymer like PBAT, the amorphous part of the polymer chains degrades much faster than the crystalline region. It is well-known that the amorphous material absorbs fluids more easily than the crystalline regime, degrading faster (low energy required). Thermal parameters associated with the melting and crystallization of the film specimens collected during the disintegration study are summarized in Table 6. T_{g} of MV570 film shifts towards lower temperature over the period examined. Short polymer chains which undergo melting around 59.6° C. disappear on the 30th day and beyond. The pronounced melting peak temperature (Tₘ) of MV570 film shifts initially towards higher temperature on day 30^{th}, is reduced significantly on the 90^{th} day, and remains the same on the 125^{th} day. Corresponding ΔH_{f} shows a similar trend as Tₘ. These results indicate that during the biodegradation process, the microorganisms secrete extra-cellular enzymes breaking the crystalline region of the polymer to make low molecular weight amorphous groups that are easily assimilated by microorganisms. After the microbial assimilation of amorphous groups, the remaining materials become more crystalline.[36] Consequently, during subsequent cooling and second heating Tc, ΔH_{c}, Tₘ, and ΔH_{f} increase on the 30^{th} day and remain almost constant over the period examined. Conformational flexibility plays an important role in the biodegradation of polymers. The more flexibility and cleavage a polymer has, the more accessible for microbes and water and hence prone to faster biodegradation. As claimed in the patent, the one-step-reactive extrusion process enables simultaneous grafting of a functional moiety, for instance, MA, onto the biodegradable polymer, which further interacts with the nanoparticles of choice to enhance the interaction between the two, as well as partial cross-linking between the polymer chain in the presence of chain extension. MA and chain extender may also react with the nanoclay. The presence of functional groups can provide sites for hydrolysis and increase the flexibility of polymer chains, hence making a polymer susceptible to biodegradation. Mohanty et al. also reported that PBAT-g-MA/Cloisite 30B nanocomposite degrades faster with respect to the PBAT/Cloisite 30B nanocomposite in the industrial composting condition.[33] The photographs of the disintegrated films and the corresponding SEM images of the surface of the disintegrated film segments at the different intervals are presented in FIG. 13 and FIG. 14, respectively. In the disintegration study set-up, the films were kept on the surface of the compost for easy sampling for further testing. However, no traces of polymeric film are noticed in the compost collected from the reactor used to study the biodegradation where films were buried in the compost. FTIR spectra of the disintegrated film segments are presented in FIGS. 15-20. Characteristic molecular vibrations of PBAT before biodegradation appear as follows (FIG. 15): 2955 cm⁻¹ represents the asymmetric stretching vibration of CH₂, 1715 cm⁻¹ represents the stretching vibration of C—O. Trans-CH-plane bending vibrations are represented by 1409 and 1395 cm⁻¹. Here it appears at 1390 cm⁻¹. Moreover, symmetric stretching vibration of C—O, C—O left-right symmetric stretching vibration absorption and bending vibration absorption at the surface of adjacent hydrogen atoms on the phenyl ring appear at 1268, 1104, and 1019 cm⁻¹, respectively. Besides these vibrations, OH intermolecular stretching of alcohol around 3200-3500 cm⁻¹ appears to have a composting period of 31 days. OH vibrations become pronounced with composting time, and as a result, a significant change in the spectral vibrations at 1104 and 1019 cm⁻¹ is observed. C═C stretching of alkene appears at 1530 cm⁻¹. Mechanisms of biodegradation of PBAT include hydrolytic degradation that mainly occurs on the ester bond between terephthalate and adipate groups, main chain scission degradation, and β-C—H hydrogen transfer.[37] The chemical degradation of polymer chains usually induces main chain scission and leads to embrittlement of the materials.[38] Alkene is one of the end products of β-C—H hydrogen transfer of PBAT. N—O stretching of nitro compound (1500-1550 cm⁻¹) is possible from the compost used for biodegradation tests. Percentages of the tomato seed germination within 15 days is tabulated in Table 5, and the representative photographs of germinated seeds and the seedling are presented in FIG. 26. According to OECD 208 standard test method, at least 50% of the seed should germinate compared to the blank compost-soil mixture. Table 5 and FIG. 26 reveals that 90% of seeds were germinated in the compost-soil mixture in the reactor at the end of the biodegradation tests. A similar extent of seed germination was noticed in the blank compost and the microcrystalline cellulose composted soil.

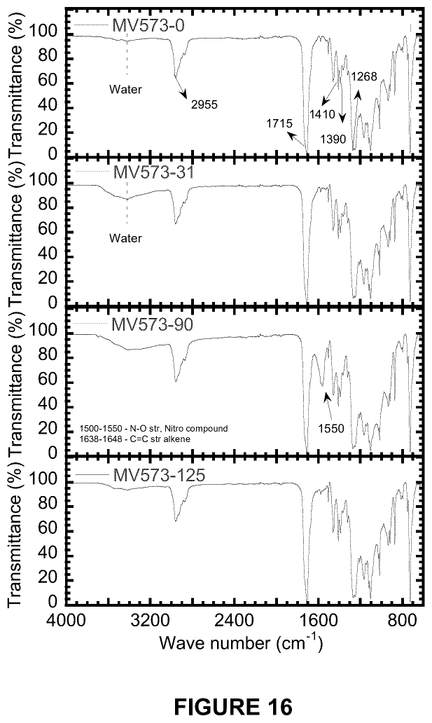

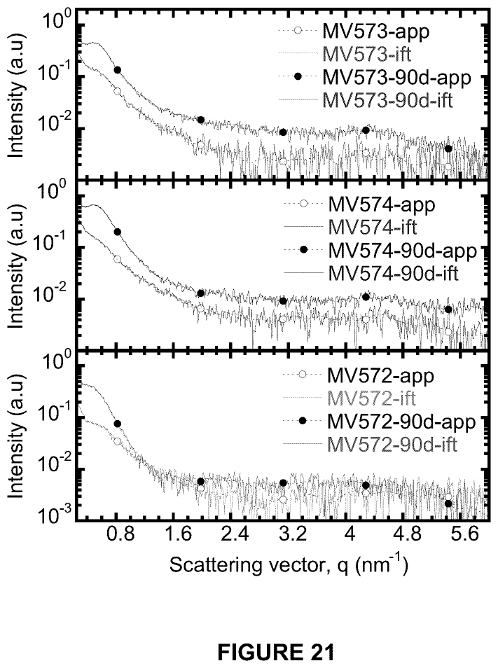

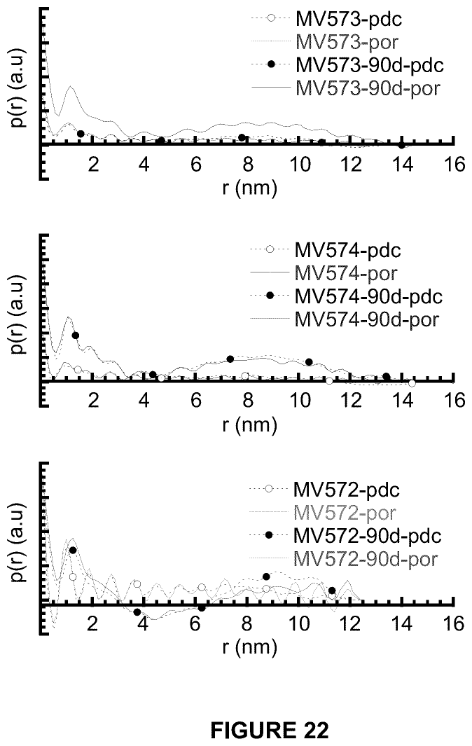

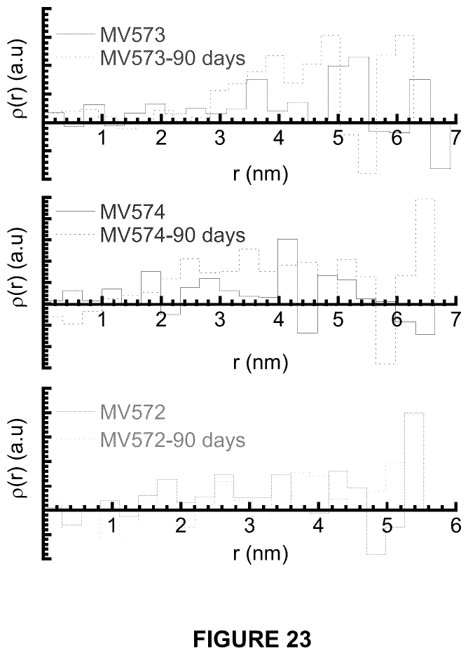

The film described in example 4 500 is composed of neat PBAT 410 as outer layers and reactively processed EFD nanoclay-containing nanocomposite 510 as the central layers. The oxygen transmission rate of this film is 307.8 cc/m²/day (refer to Table 3). Approximately 31.5% reduction in oxygen transmission rate is achieved in example 4 compared to the comparative example 3. The reduction in the oxygen transmission rate is attributed to the tortuous path created by the dispersed nanoclay in the reactively processed nanocomposite 510. Reactive processing improves the compatibilization of PBAT and the nanoclay, which results in the highly delaminated structure of the nanocomposite 510. The dimensional stability measured in machine and transverse directions are respectively 2.3% and 0.3% (refer to Table 3). A negative sign represents the shrinkage of the films. Therefore, 61.6% and 85% improvements in the dimensional stability are achieved in the machine and the transverse direction, respectively, in the disclosed nanocomposite film compared with the comparative example 3. Amorphous segments in the polymer have a natural random chain orientation, and hence less relaxation is expected than the crystalline segments. Moreover, during film blowing, the polymer is subjected to flow-induced stress orientation and mechanical stretching, which can undergo relaxation at elevated temperature and result in shrinkage. The nanoclay platelets in the composite-based films can inhibit such polymer relaxation. Again, the nanoclay-containing composites possess less overall crystallinity, as indicated by the lower value of ΔH_{f} in Table 2, than the neat PBAT. The composite films exhibit dimensional stability probably due to the lower crystallinity of the composite and less polymer chain relaxation phenomenon. Tensile modulus, load at yield, ultimate tensile stress (UTS), and the elongation at break of the said film in the machine direction are respectively 90.0±7.3 MPa, 54.1±3.7 N, 20.8±1.4 MPa, and 620.9±47.2%. Those in the transverse direction are respectively 102.7±14.3 MPa, 22.6±2.7 N, 17.4±4.8 MPa, and 660.5±165.1% (Refer to Table 4). Therefore, the disclosed film exhibits significant improvement in tensile properties compared to the comparative example 3. Such a significant improvement in oxygen transmission rate, dimensional stability, and tensile properties can be attributed to the effective compatibilization and the dispersion/distribution of nanoclay achieved by reactive processing of the nanocomposite 510. FIG. 11 shows the trend of water vapor transmission over time, and the film described in example 4 shows a higher transmission rate when compared with the comparative example 3. Compatibilization between the polymer and the nanoclay improves the dispersion and distribution of nanoclay in the nanocomposite, which creates an impenetrable barrier to oxygen molecules and retards oxygen permeation by creating a tortuous path when integrated into the multi-layered film. However, such film cannot provide a sufficient water vapor barrier unless a high aspect ratio of nanoclay is maintained in the nanocomposites; a smaller volume of water molecule than that of oxygen also affects the permeability properties. FIG. 12 shows the caCO₂ evolution during the testing of industrial compostability. MV573 film degrades 19.4% and 58% in 70 and 180 days, respectively. In MV573 film, the core nanocomposite layers are protected by the neat PBAT. Changes in the thermal parameters over time can be attributed to the biodegradation of different layers in multi-layered films. Biodegradation of the composite depends on the hydrolysis of PBAT rendered by the type of nanofillers present in the composite. For instance, the mechanism of water-sorption characteristics of EFD (montmorillonite) is a function of the structure and the exchangeable cation. According to Table 5 and FIG. 12, the biodegradability of the different films follows the trend MV574>MV573>MV570≥MV572. The cation exchange capacity (CEC) of EFD is 50 meq/100 g, whereas the CEC of montmorillonite is 92.6 meq/100 g. Lower CEC of EFD nanoclay results reduction in biodegradation in MV573. The photographs of the disintegrated film and the corresponding SEM images of the surface of the disintegrated film segments at the different intervals are presented in FIG. 13 and FIG. 14, respectively. Larger voids and structural disintegration are pronounced in MV573. FTIR spectra of the disintegrated film segments is presented in FIG. 16, and it is evident that the biodegradation via main chain scission is pronounced in the MV573. The absence of alkene vibration indicates that biodegradation via β-C—H hydrogen transfer is suppressed in the composite films. Therefore, the composite films mainly degrade via hydrolytic degradation and main chain scission, whereas biodegradation of neat PBAT can involve all three mechanisms discussed here. The scattering pattern in the small angle region after background (PBAT) subtraction is presented in FIG. 21. Long-range periodic orders of the PBAT chain appears around 0.6 nm in all the films tested and become more pronounced after 90 days of composting. The characteristic diffraction of EFD and Kaolin appears at 8.7° and 9°, respectively, corresponding to 6.18 and 6.32 nm⁻¹ in terms of scattering vector (q). Characteristic scattering of these nanoclays appears around 4.4 nm⁻¹ in all the composite films confirming the intercalation of PBAT chains in the nanoclay galleries. From these patterns, the long period was determined using equation 3 according to Bragg's law:[38]

$${L}_{p} = \frac{2 π}{{q}_{max}} \qquad ( 3 )$$

Where Lₚ is the long period expressed in nm and qₘₐₓ=0.6 nm⁻¹. The crystalline (I_{c}) and amorphous (Iₐ) layer thickness can then be determined according to equations 4 and 5, respectively. X_{c} is the degree of crystallinity in the films determined using equation 6.

$${l}_{c} = {X}_{c} . \frac{{L}_{p} {ρ}_{a}}{{ρ}_{c} - {x}_{c} ( {ρ}_{c} - {ρ}_{a} )} \qquad ( 4 )$$

$${l}_{a} = {L}_{p} - {l}_{c} \qquad ( 5 )$$

Where ρₐ and ρ_{c} are the amorphous and crystalline densities and are respectively equal to 1.23 g·cm⁻³ and 1.36 g·cm⁻³. [39]

$${X}_{c} = \frac{Δ {H}_{f}}{Δ {H}_{f}^{0}} \qquad ( 6 )$$

Where, ΔH_{f} is the enthalpy of fusion measure from the first heating, ΔH_{f} is the enthalpy of a 100% crystalline PBAT equal to 114 J/g.[40] X_{c}, Lₚ, I_{c}, and Iₐ at 0 and 90 days are tabulated in Table 7. While X_{c} shows an increasing trend in MV570 after 90 days, it remains constant in the MV573 film. Lₚ is constant for all the films examined. As Iₐ decreases in MV570 film after 90 days of biodegradation (disintegration), the I_{c} increases and can be interpreted as a lamellar thickening. This decrease in Iₐ is due to the chemi-crystallization process during PBAT hydrolysis. No significant changes in I_{c} and Iₐ are noticed in the composite films. Therefore, hydrolysis of PBAT delays minimally in the composite films than MV570 film. According to FIG. 12, the trend of biodegradation after 90 days follows the order MV574>MV573>MV570>MV572. As observed from the FTIR biodegradation via β-C—H, hydrogen transfer is suppressed in the composite films. Hence, the main chain scission is the driving factor for biodegradation of the composite films at the initial phase. The pair distance distribution function (p(r)) and the corresponding electron density profiles (ρ(r)) were determined from scattering patterns by using generalized indirect Fourier transformation (GIFT) and presented in FIGS. 22 and 23, respectively. The experimental scattering curves are denoted by the extension *.ift, and the approximated scattering curves determined theoretically using the GIFT method are denoted by the extension *.app. Since both patterns overlap, the p(r) estimated by the GIFT method should represent the p(r) for the experimental scattering curve. Furthermore, the deconvolution of approximated electron density profile by DECON provides information on p(r). Since the nature of p(r) determined by GIFT and DECON are similar, then it is obvious that the electron density distribution (ρ(r)) determined by DECON should represent the experimental scattering curve. The probability of finding neighboring nanoclay in MV573, MV574 and MV572 are respectively 15.6, 18, and 12.5 nm. This indicates the distribution of nanoclay improves in the order: MV574>MV573>MV572. FIG. 22 shows three main correlation peaks in MV573 that appear around 1.5, 2, and 2.8 nm. These correlation maxima indicate the probability of finding neighboring nanoclay particles, and as observed in FIG. 22, the probability of finding neighboring EFD platelets within the range of 4 and 14 nm increase after 90 days of biodegradation. The electron density profiles presented in FIG. 23 indicate of a few single EFD platelets of thickness approximately 1 nm, along with stacks of approximately 4 to 5 platelets (as evinced between 1.4 and 5.6 nm). This trend remains the same after 90 days of biodegradation. The change in crystal structure before and after 90 days of biodegradation/disintegration is evident in FIG. 25. The diffraction peaks of PBAT crystals appear at 16.2, 17.3, 20.4, 23.2, and 24.8°. Before biodegradation, the PBAT peaks appear in the same position except one at 17.3°; it appears at 18.5°. However, after biodegradation, a new peak appears at 17.6°. The increase in the peak intensities after biodegradation supports the hydrolytic degradation and increase in the crystallinity. Table 5 and FIG. 26 reveals that 90% of seeds were germinated in the compost-soil mixture in the reactor at the end of the biodegradation tests.

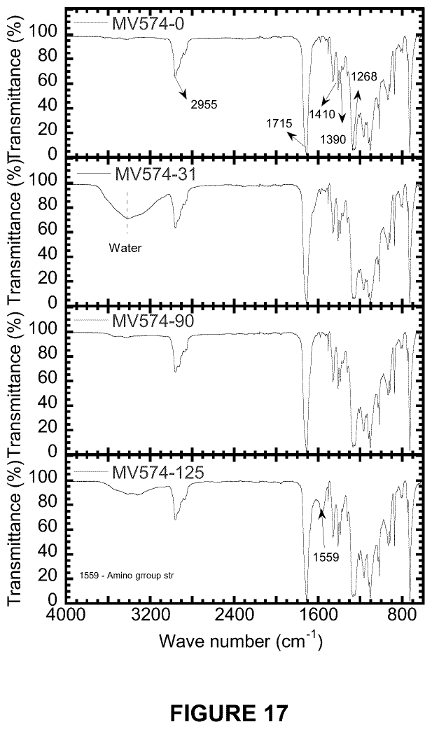

The film described in example 5 600 is composed of neat PBAT 410 as outer layers and reactively processed EFD nanoclay-containing nanocomposite 510 and kaolin nanoclay-containing nanocomposite 610 as the central layers. The oxygen transmission rate of this film is 312.3 cc/m²/day (refer to Table 3). Approximately 30.5% reduction in oxygen transmission rate is achieved in example 5 when compared with the comparative example 3. The reduction in the oxygen transmission rate is attributed to the tortuous path created by the dispersed nanoclay in the reactively processed nanocomposites. Reactive processing improves the compatibilization of PBAT and the nanoclays, which results in highly delaminated structure of the nanocomposites 510. The dimensional stability measured in machine and transverse directions are 3.5% and 0% (refer to Table 3). A negative sign represents the shrinkage of the films. Therefore, 41.7% and 100% improvements in the dimensional stability are achieved in the machine and the transverse direction, respectively, in the disclosed nanocomposite film compared with the comparative example 3. Tensile modulus, load at yield, ultimate tensile stress (UTS), and the elongation at break 068 of the said film in the machine direction are respectively 80.7±14.9 MPa, 49.0±3.9 N, 18.9±1.5 MPa, and 702.3±27.3%. Those in the transverse direction are respectively 100.3±13.6 MPa, 20.9±0.5 N, 20.9±3.0 MPa, and 896.9±103.0% (refer to Table 4). Therefore, the disclosed film exhibits significant improvement in tensile properties compared to the comparative example 3. Such a significant improvement in oxygen transmission rate, dimensional stability, and tensile properties can be attributed to the effective compatibilization and the dispersion/distribution of nanoclay achieved by reactive processing of the nanocomposites 510 610. FIG. 12 shows the CO₂ evolution during the testing of industrial compostability. MV574 film degrades 22.6% and 82% in 70 and 180 days, respectively. In MV574 film, the core nanocomposite layers are protected by the neat PBAT. Changes in the thermal parameters over time can be attributed to the biodegradation of different layers in multi-layered films. No significant changes in I_{c} and Iₐ are noticed in the composite films. Therefore, hydrolysis of PBAT delays minimally in the composite films than MV570 film. Biodegradation of the composite depends on the hydrolysis of PBAT rendered by the type of nanofillers present in the composite. For instance, absorption after the initial sorption is probably the splitting apart of kaolin aggregates or booklets weakly bonded by stretched hydrogen bonds or van der Waal's forces. Whereas the mechanism of water-sorption characteristics of EFD (montmorillonite) is a function of the structure and the exchangeable cation. According to Table 5 and FIG. 12, the biodegradability of the different films follows the trend MV574>MV573>MV570≥MV572. The cation exchange capacity (CEC) of EFD is 50 meq/100 g, whereas the CEC of montmorillonite is 92.6 meq/100 g. Lower CEC of EFD nanoclay results reduction in biodegradation in MV573. Therefore, the presence of kaolin in the composite plays an important role in the biodegradability of the PBAT film of thickness of approximately 120 μm. Girdthep et al. investigated the compostability of the blended composite of polylactic acid, PBAT, and silver-loaded kaolin (Ag-KT) in the powder form. They reported that Ag-KT in the blended composite retarded the biodegradation of the PLA-PBAT blend, and the composite degraded by 69.9% in 90 days.[41] Such results cannot be compared with those disclosed here because of the silver loading of the kaolin and the sample form used for testing the biodegradability. The photographs of the disintegrated film and the corresponding SEM images of the surface of the disintegrated film segments at the different intervals are presented in FIG. 13 and FIG. 14, respectively. Larger voids and structural disintegration are noticed in MV574 film, like MV573. Possible growth of isolated bacteria is evinced in MV574 after 90 days. As a result, MV574 attains 82% biodegradation, whereas MV570 attains only 53% biodegradation. FTIR spectra of the disintegrated film segments are presented in FIG. 17, and it is evident that in the presence of Kaolin nanoclay in MV574 film, main chain scission reduces slightly. The absence of alkene vibration indicates that biodegradation via β-C—H hydrogen transfer is suppressed in the composite films. Therefore, the composite films mainly degrade via hydrolytic degradation and main chain scission, whereas biodegradation of neat PBAT can involve all three mechanisms discussed here. The scattering pattern in the small angle region after background (PBAT) subtraction is presented in FIG. 21. According to FIG. 12, the trend of biodegradation after 90 days follows the order MV574>MV573>MV570>MV572.

As observed from the FTIR biodegradation via β-C—H, hydrogen transfer is suppressed in the composite films. Hence, the main chain scission is the driving factor for the biodegradation of the composite films at the initial phase. The probability of finding neighboring nanoclay in MV573, MV574, and MV572 are 15.6, 18, and 12.5 nm, respectively. This indicates distribution of nanoclay improves in the order: MV574>MV573>MV572. According to FIG. 22, MV574 film follows a similar trend as MV573 film. The electron density profiles presented in FIG. 23 indicate the presence of 1 to stack of 4 platelets observed in MV574 film. The change in crystal structure before and after 90 days of biodegradation/disintegration is evident in FIG. 25. MV574 film showed a similar trend as MV573 film. Table 5 and FIG. 26 reveals that the 100% seeds were germinated in the compost-soil mixture in the reactor at the end of the biodegradation tests.

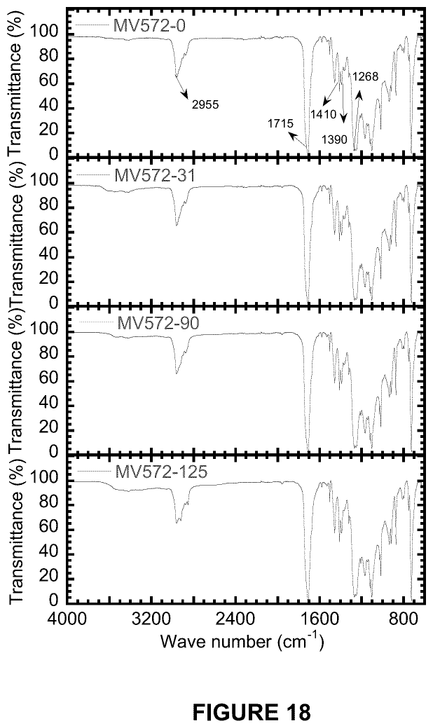

The film described in example 6 700 is composed of neat PBAT 410 as outer layers and EFD nanoclay-containing nanocomposite prepared without reaction 710, and kaolin nanoclay-containing nanocomposite 610 as the central layers. The oxygen transmission rate of this film is 339.2 cc/m²/day (refer to Table 3). Approximately 24.5% reduction in oxygen transmission rate is achieved in example 6 compared to the comparative example 3. The presence of agglomerated EFD nanoclay in the EFD w/o rxn 710 (refer to FIG. 10) creates a less tortuous path for the diffused oxygen molecules, and hence the MV572 film exhibits the lowest reduction in the OTR. The dimensional stability measured in machine and transverse directions are respectively 3.8% and 0% (refer to Table 3). A negative sign represents the shrinkage of the films. Therefore, 36.7% and 100% improvements in the dimensional stability are achieved in the machine and the transverse direction, respectively in the disclosed nanocomposite film compared with the comparative example 3. Tensile modulus, load at yield, ultimate tensile stress (UTS), and the elongation at break 068 of the said film in the machine direction are respectively 84.5±15.2 MPa, 17.8±1.8 N, 15.2±2.4 MPa, and 537.6±84.9%. Those in the transverse direction are respectively 91.6±18.1 MPa, 21.8±1.9 N, 13.4±1.0 MPa, and 455.7±90.4% (refer to Table 4). Therefore, the disclosed film exhibits similar tensile properties to comparative example 3. FIG. 12 shows the CO₂ evolution during the testing of industrial compostability. MV572 film degrades 4% and 51% in 70 and 180 days, respectively. In MV572 film, the core nanocomposite layers are protected by the neat PBAT. Changes in the thermal parameters over time can be attributed to the biodegradation of different layers in multi-layered films. No significant changes in I_{c} and Iₐ are noticed in the composite films. Therefore, hydrolysis of PBAT delays minimally in the composite films than MV570 film. Biodegradation of the composite depends on the hydrolysis of PBAT rendered by the type and dispersion of nanofillers present in the composite. Table 5 and FIG. 12 show that the biodegradability of the MV572 films is like the MV570 film. The photographs of the disintegrated films and the corresponding SEM images of the surface of the disintegrated film segments at the different intervals are presented in FIG. 13 and FIG. 14, respectively. Formation of small voids is evident in MV572 after 90 days. FTIR spectra of the disintegrated film segments is presented in FIG. 18, and it is evident that biodegradation occurs mainly via main chain scission in MV572 film. The scattering patterns in the small angle region after background (PBAT) subtraction are presented in FIG. 21. A significant change in p(r) is noticed in MV572 before and after 90 days of biodegradation. Apparently, agglomerated nanoclays present in the film separate after 90 days, probably when the sorption by the central composite layer comprised of kaolin triggers. The electron density profiles presented in FIG. 23 show that MV572 film exhibits a similar trend as MV573 film. The change in crystal structure before and after 90 days of biodegradation/disintegration is evident in FIG. 25. MV572 film showed a similar trend as MV573 film. Table 5 and FIG. 26 reveals that the 100% seeds were germinated in the compost-soil mixture in the reactor at the end of the biodegradation tests.

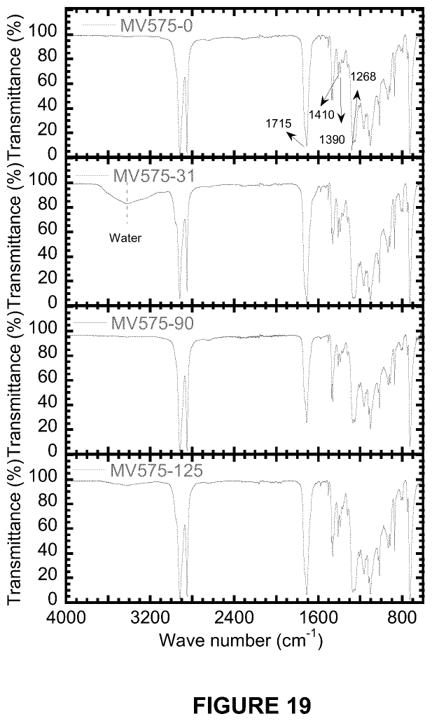

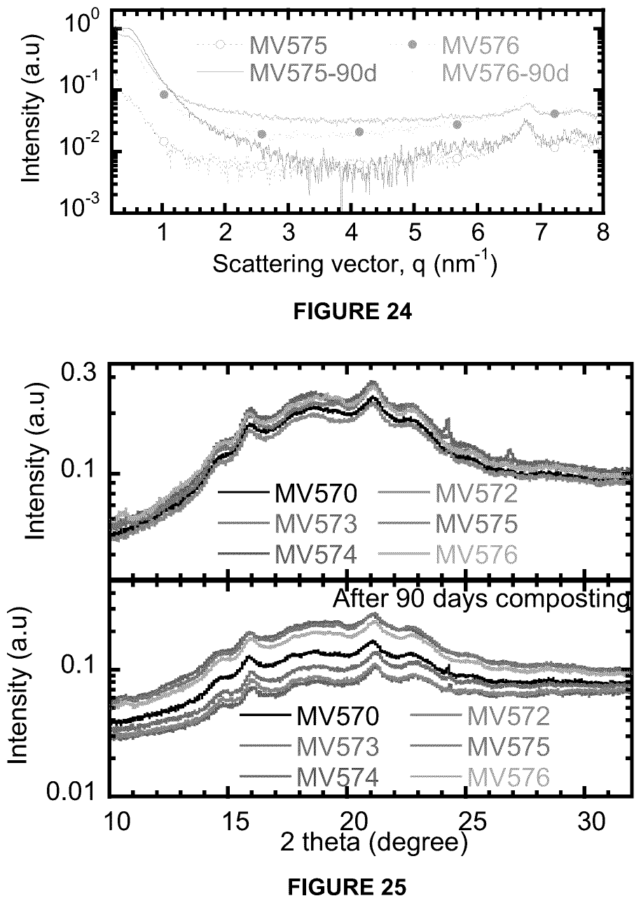

The film described in example 7 800 is composed of neat PBAT 410 as outer layers and reactively processed MOF nanoclay-containing nanocomposite 810 as the central layers. The oxygen transmission rate of this film is 328.2 cc/m²/day (refer to Table 3). Approximately 27% reduction in oxygen transmission rate is achieved in example 7 when compared with the comparative example 3. The reduction in the oxygen transmission rate is attributed to the high surface area (BET surface area of 744.9 m²/g) and the tortuous path created by the MOF nanoparticles in the reactively processed nanocomposites. The dimensional stability measured in machine and transverse directions are respectively 2.5% and 1% (refer to Table 3). A negative sign represents the shrinkage of the films. Therefore, 58.3% and 83.3% improvements in the dimensional stability are achieved in the machine and the transverse direction, respectively, in the disclosed nanocomposite film when compared with the comparative example 3. Tensile modulus, load at yield, ultimate tensile stress (UTS), and the elongation at break of the said film in the machine direction are respectively 96.2±15.0 MPa, 43.2±3.1 N, 18.0±1.3 MPa, and 624.2±37.2%. Those in the transverse direction are respectively 74.1±19.8 MPa, 30.7±5.3 N, 12.8±2.2 MPa, and 445.6±50.9% (refer to Table 4). Therefore, the disclosed film exhibits significantly similar tensile properties to the comparative example 3. FIG. 11 shows the trend of water vapor transmission over time, and the film described in example 7 shows a significant reduction in the transmission rate when compared with the comparative example 3, probably due to the high surface area and the single point adsorption total pore volume of pores (0.47 cm³/g). FIG. 12 shows the CO₂ evolution during the testing of industrial compostability. MV575 film degrades approximately 10% and 79.3% in 70 and 180 days, respectively. Therefore, the presence of MOF in the composite plays an important role in the biodegradability of the PBAT film, which is approximately 120 μm. The photographs of the disintegrated film and the corresponding SEM images of the surface of the disintegrated film segments at the different intervals are presented in FIG. 13 and FIG. 14, respectively. Void formation and structural disintegration are noticed in MV575 film. FTIR spectra of the disintegrated film segments are presented in FIG. 19. MV575 film shows bond vibrations like the nanocomposite films comprising nanoclays. Therefore, the disclosed MV575 film is expected to degrade via hydrolytic degradation and main chain scission mainly. In contrast, biodegradation of neat PBAT can involve all three mechanisms discussed here. No significant changes in I_{c} and Iₐ are noticed in the composite films. Therefore, hydrolysis of PBAT delays minimally in the composite films than MV570 film. The scattering patterns of MV575 film are presented in FIG. 24. The characteristic X-ray diffraction of MOF appears at 10.6°, which corresponds to the scattering vector 7.5 nm⁻¹. Therefore, shifting this peak position to 6.8 nm⁻¹ indicates the dispersion of the nanoparticles in the PBAT matrix. Though most of the MOF nanoparticles were well-dispersed, some agglomeration is evidenced by the appearance of the small hump around 7.5 nm⁻¹. The change in crystal structure before and after 90 days of biodegradation/disintegration is evident in FIG. 25. MV575 film showed a similar trend as MV573 film. Table 5 and FIG. 26 reveals that the 100% seeds were germinated in the compost-soil mixture in the reactor at the end of the biodegradation tests.

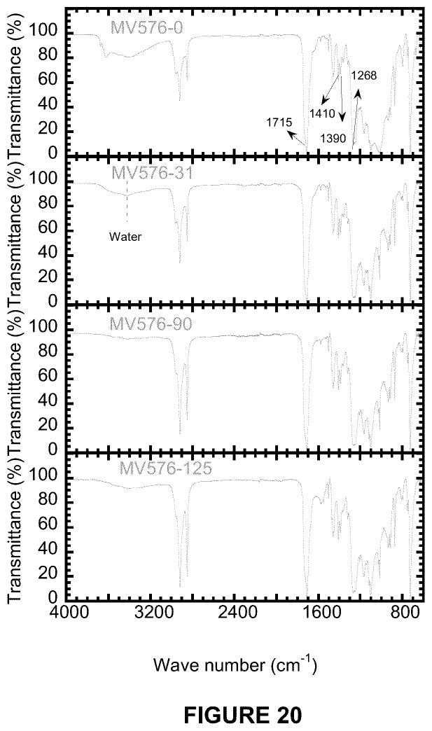

The film described in example 8 900 is composed of neat PBAT 410 as outer layers and reactively processed MOF nanoclay-containing nanocomposite 810 and kaolin nanoclay-containing nanocomposite 610 as the central layers. The oxygen transmission rate of this film is 366.4 cc/m²/day (refer to Table 3). Approximately 18.5% reduction in oxygen transmission rate is achieved in example 8 compared to the comparative example 3. Less reduction in the oxygen transmission rate compared to the other nanocomposite films indicates poor interfaces between the layers in the MV576 film. The dimensional stability measured in machine and transverse directions are respectively 2.6% and 1% (refer to Table 3). A negative sign represents the shrinkage of the films. Therefore, similar improvements like MV575 film are achieved in the disclosed nanocomposite film compared with the comparative example 3. Tensile modulus, load at yield, ultimate tensile stress (UTS), and the elongation at break 068 of the said film in the machine direction are respectively 107.0±7.0 MPa, 35.0±8.8 N, 15.0±3.2 MPa, and 604.1±149.4%. Those in the transverse direction are respectively 103.9±15.8 MPa, 31.5±3.6 N, 13.2±1.6 MPa, and 574.2±157.9% (refer to Table 4). Therefore, the disclosed film exhibits improved tensile properties than the comparative example 3. FIG. 12 shows the CO₂ evolution during the testing of industrial compostability. MV576 film degrades approximately 22% and 86.9% in 70 and 180 days, respectively. Therefore, MOF and kaolin nanoclay play an important role in the biodegradability of the PBAT film of thickness approximately 120 μm. The photographs of the disintegrated film and the corresponding SEM images of the surface of the disintegrated film segments at the different intervals are presented in FIG. 13 and FIG. 14, respectively. Void formation and structural disintegration are noticed in MV576 film. FTIR spectra of the disintegrated film segments are presented in FIG. 20. MV576 film shows bond vibrations like the nanocomposite films comprising nanoclays. Therefore, the disclosed MV576 film is expected to degrade via hydrolytic degradation and main chain scission. In contrast, biodegradation of neat PBAT can involve all three mechanisms discussed here. No significant changes in I_{c} and Iₐ are noticed in the composite films. Therefore, hydrolysis of PBAT delays minimally in the composite films than MV570 film. The scattering patterns of MV576 film are presented in FIG. 24. Dispersion of MOF nanoparticles in MV576 is like MV575 film. The change in crystal structure before and after 90 days of biodegradation/disintegration is evident in FIG. 25. MV576 film showed a similar trend as MV573 film. Table 5 and FIG. 26 reveals that the 100% seeds were germinated in the compost-soil mixture in the reactor at the end of the biodegradation tests.

TABLE 1
Characteristics of the nanocomposites comprised of nanoclay at different loadings

| | | | | | | | MFR (g/10 |
|---|---|---|---|---|---|---|---|
| | | | | | | | min) |
| | T_{c} | ΔH_{c} | T_{g} | Tₘ | ΔH_{f} | Grating | (at 190° C., |
| Sample | (° C.) | (J · g⁻¹) | (° C.) | (° C.) | (J · g⁻¹) | (%) | 2.16 kg) |
| PBAT | 67.0 | 21.0 | −31.2 | 120.6 | 13.4 | | 5.7 |
| PBAT-g-MA | 69.0 | 19.3 | −27.0 | 123.1 | 12.1 | 3.6 | 5.1 |
| 2.1 wt % | 66.7 | 20.0 | −31.9 | 120.9 | 12.2 | 2.2 | 10.2 |
| Nanoclay, | | | | | | | |
| reaction | | | | | | | |
| 3.5 wt % | 66.2 | 19.7 | −30.0 | 122.0 | 12.4 | 2.3 | 9.9 |
| Nanoclay, | | | | | | | |
| reaction | | | | | | | |
| 4.9 wt % | 67.7 | 20.0 | −27.9 | 121.4 | 11.4 | 1.7 | 7.7 |
| Nanoclay, | | | | | | | |
| reaction | | | | | | | |

TABLE 2
Characteristics of the nanocomposites comprised of different nanofillers.

| | | | | | | | | MFR |
|---|---|---|---|---|---|---|---|---|
| | | | | | | | | (g/10 |
| | Inorganic | | | | | | | min) |
| | content at | | | | | | | (At |
| | 750° C. | T_{0.05} | T_{c} | ΔH_{c} | T_{g} | Tₘ | ΔH_{f} | 150° C., |
| Sample | (wt %) | (° C.) | (° C.) | (J · g⁻¹) | (° C.) | (° C.) | (J · g⁻¹) | 2.16 kg) |
| PBAT | | 358.0 | 39.1 | 18.6 | −28.6 | 119.5 | 7.5 | 1.8 |
| EFD rxn | 5.4 ± 0.87 | 344.8 | 69.0 | 17.5 | −28.2 | 119.6 | 5.2 | 3.1 |
| Kaolin rxn | 5.0 ± 0.97 | 339.7 | 76.7 | 16.0 | −28.2 | 121.4 | 5.2 | 2.7 |
| EFD w/o rxn | 3.4 ± 0.97 | 349.7 | 68.2 | 15.7 | −27.3 | 119.8 | 5.9 | 2.2 |
| MOF rxn | 2.5 ± 0.79 | 341.7 | 76.7 | 16.0 | −34.1 | 121.4 | 5.5 | 2.5 |

TABLE 3
Oxygen transmission rate and the dimensional stability of multi-layered films.

| | | O₂ | | |
|---|---|---|---|---|
| | | transmission | | |
| | | rate measured | Dimensional | Dimensional |
| | | in cc/m²/day @ | change in | change in |
| Film code | Layer construction | 23° C. & 0% RH | MD (%) | TD (%) |
| FY951 | PBS \| PBAT \| PBAT \| PBAT \| PBS | 850.1 | −2.7 | −0.3 |
| FY952 | PBS \| PBAT-g-MA (3 layers) \| PBS | 1145.6 | −8.0 | 0 |
| FY954 | PBS \| 2.1 wt % EFD nanoclay (3 layers) \| PBS | 93.8 | −3.0 | 0 |
| FY955 | PBS \| 3.5 wt % EFD nanoclay (3 layers) \| PBS | 92.4 | −1.3 | 0 |
| FY953 | PBS \| 4.9 wt % EFD nanoclay (3 layers) \| PBS | 1133.8 | −9.0 | 0 |
| MV570 | PBAT \| PBAT \| PBAT \| PBAT \| PBAT | 449.5 | −6.0 | −2.0 |
| MV573 | PBAT \| EFD rxn \| EFD rxn \| EFD rxn \| PBAT | 307.8 | −2.3 | −0.3 |
| MV574 | PBAT \| EFD rxn \| Kaolin rxn \| EFD rxn \| PBAT | 312.3 | −3.5 | 0 |
| MV572 | PBAT \| EFD w/o rxn \| Kaolin rxn \| EFD w/o rxn \| PBAT | 339.2 | −3.8 | 0 |
| MV575 | PBAT \| MOF rxn \| MOF rxn \| MOF rxn \| PBAT | 328.2 | −2.5 | −1.0 |
| MV576 | PBAT \| MOF rxn \| Kaolin rxn \| MOF rxn \| PBAT | 366.4 | −2.6 | −1.0 |

TABLE 4
Tensile properties of multi-layered films.

| | Machine direction | | | | Transverse direction | | | |
|---|---|---|---|---|---|---|---|---|
| | Tensile | | | Elongation | Tensile | | | Elongation |
| Film | modulus | Load at | UTS | at break | modulus | Load at | UTS | at break |
| code | (MPa) | yield (N) | (MPa) | (%) | (MPa) | yield (N) | (MPa) | (%) |
| MV570^{a} | 91.1 ± 12.3 | 33.5 ± 2.4 | 13.9 ± 1.0 | 489.8 ± 94.1 | 73.3 ± 14.9 | 26.4 ± 3.8 | 11.1 ± 1.6 | 467.8 ± 117.6 |
| MV573^{b} | 90.7 ± 7.3 | 54.1 ± 3.7 | 20.8 ± 1.4 | 620.9 ± 47.2 | 102.7 ± 1.4 | 22.6 ± 2.7 | 17.4 ± 4.8 | 660.5 ± 165.1 |
| MV574^{c} | 80.7 ± 14.9 | 49.0 ± 3.9 | 18.9 ± 1.5 | 702.3 ± 27.3 | 100.3 ± 13.6 | 20.9 ± 0.5 | 20.9 ± 3.0 | 896.9 ± 103.0 |
| MV572^{d} | 84.5 ± 15.2 | 17.8 ± 1.8 | 15.2 ± 2.4 | 537.6 ± 84.9 | 91.6 ± 18.1 | 21.8 ± 1.9 | 13.4 ± 1.0 | 455.7 ± 90.4 |
| MV575^{e} | 96.2 ± 15.0 | 43.2 ± 3.1 | 18.0 ± 1.3 | 624.2 ± 37.2 | 74.1 ± 19.8 | 30.7 ± 5.3 | 12.8 ± 2.2 | 445.6 ± 50.9 |
| MV576^{f} | 107.0 ± 7.0 | 35.0 ± 8.8 | 15.0 ± 3.2 | 604.1 ± 149.4 | 103.9 ± 15.8 | 31.5 ± 3.6 | 13.2 ± 1.6 | 574.2 ± 157.9 |

^{a}MV570: PBAT | PBAT | PBAT | PBAT | PBAT;
^{b}MV573: PBAT | EFD rxn | EFD rxn | EFD rxn | PBAT;
^{c}MV574: PBAT | EFD rxn | Kaolin rxn | EFD rxn | PBAT; and
^{d}MV572: PBAT | EFD w/o rxn | Kaolin rxn | EFD w/o rxn | PBAT;
^{e}MV575: PBAT | MOF rxn | MOF rxn | MOF rxn | PBAT; PBAT | MOF rxn | MOF rxn | MOF rxn | PBAT;
^{f}MV576: PBAT | MOF rxn | kaolin rxn | MOF rxn | PBAT

TABLE 5
Biodegradability of different films and percentage of seed germination
in the compost at the end of the biodegradation study.

| | | | | | | Seed |
|---|---|---|---|---|---|---|
| | | | | | | germination |
| | Weight | Carbon | Carbon | ThCO₂ | % | within 15 |
| Film code | (g) | (%) | (g) | (g) | Biodegradation | days (%) |
| Blank compost | | | | | | 90 |
| Microcrystalline | 25.1 | 42.3 | 10.6 | 38.9 | 95 | 90 |
| cellulose | | | | | | |
| MV570^{a} | 25.0 | 68.1 | 17.0 | 62.5 | 53 | 100 |
| MV573^{b} | 25.1 | 61.4 | 15.4 | 56.5 | 58 | 90 |
| MV574^{c} | 25.1 | 62.3 | 15.6 | 57.3 | 82 | 100 |
| MV572^{d} | 25.2 | 62.3 | 15.6 | 57.5 | 51 | 100 |
| MV575^{e} | 25.1 | 62.0 | 15.6 | 57.1 | 79 | 100 |
| MV576^{f} | 25.1 | 61.8 | 15.5 | 56.9 | 87 | 100 |

^{a}MV570: PBAT | PBAT | PBAT | PBAT | PBAT;
^{b}MV573: PBAT | EFD rxn | EFD rxn | EFD rxn | PBAT;
^{c}MV574: PBAT | EFD rxn | Kaolin rxn | EFD rxn | PBAT; and
^{d}MV572: PBAT | EFD w/o rxn | Kaolin rxn | EFD w/o rxn | PBAT;
^{e}MV575: PBAT | MOF rxn | MOF rxn | MOF rxn | PBAT; PBAT | MOF rxn | MOF rxn | MOF rxn | PBAT;
^{f}MV576: PBAT | MOF rxn | kaolin rxn | MOF rxn | PBAT

TABLE 6
Parameters associated with the melting and crystallization of the specimens
collected during certain intervals of decomposition study.

| | Sampling | Heating - 1 | | | | Cooling | | | | Heating - 2 | | |
|---|---|---|---|---|---|---|---|---|---|---|---|---|
| Film | time | T_{g} | Tₘ₁ | Tₘ | ΔH_{f} | T_{c1} | ΔH_{c1} | T_{c2} | ΔH_{c2} | T_{g} | Tₘ | ΔH_{f} |
| code | (day) | (° C.) | (° C.) | (° C.) | (J · g⁻¹) | (° C.) | (J · g⁻¹) | (° C.) | (J · g⁻¹) | (° C.) | (° C.) | (J · g⁻¹) |
| MV570^{a} | 0 | −27.6 | 59.6 | 119.0 | 9.0 | 75.4 | 16.1 | | | −28.0 | 122.3 | 7.4 |
| | 31 | −30.2 | | 122.6 | 13.9 | 66.8 | 19.3 | | | −28.0 | 125.3 | 9.6 |
| | 90 | −33.8 | | 110.8 | 13.2 | 89.9 | 23.1 | | | −30.4 | 125.1 | 9.2 |
| | 125 | −33.2 | | 110.1 | 13.4 | 97.6 | 24.4 | | | −31.8 | 131.3 | 9.7 |
| MV573^{b} | 0 | −27.7 | 51.9 | 120.6 | 9.9 | 71.1 | 18.9 | | | −28.7 | 123.3 | 8.6 |
| | 31 | −32.8 | | 123.5 | 13.6 | 84.8 | 21.9 | | | −31.2 | 125.5 | 10.0 |
| | 91 | −32.0 | 42.3 | 109.9 | 11.0 | 97.8 | 19.9 | | | −30.9 | 130.1 | 7.5 |
| | 125 | −30.8 | | 139.0 | 22.4 | 116.0 | 17.6 | | | −31.8 | 136.5 | 6.9 |
| MV574^{c} | 0 | −29.6 | 50.1 | 120.0 | 9.4 | 70.3 | 18.5 | | | −29.1 | 124.1 | 8.1 |
| | 31 | −32.0 | | 125.9 | 11.8 | 85.2 | 22.6 | | | −29.8 | 124.8 | 9.2 |
| | 90 | −36.5 | 41.8 | 108.5 | 9.7 | 96.8 | 19.3 | | | −32.2 | 132.6 | 7.5 |
| | 125 | −30.9 | 46.2 | 140.0 | 16.6 | 120.6 | 20.2 | | | −28.3 | 141.1 | 7.7 |
| MV572^{d} | 0 | −26.6 | 50.1 | 119.9 | 8.8 | 73.3 | 17.0 | | | −28.4 | 122.4 | 7.6 |
| | 31 | −32.4 | | 123.3 | 13.9 | 75.8 | 21.9 | | | −30.1 | 126.2 | 10.3 |
| | 90 | | 41.4 | 127.8 | 8.7 | 96.4 | 20.1 | | | −32.6 | 131.0 | 6.8 |
| | 125 | | 43.5 | 102.5 | 16.6 | 120.4 | 14.5 | | | −37.4 | 147.9 | 8.5 |
| MV575^{e} | 0 | −30.0 | 49.1 | 125.3 | 10.8 | 112.6 | 2.8 | 75.0 | 84.6 | −29.0 | 126.3 | 10.3 |
| | 31 | −32.8 | 81.9 | 125.6 | 10.9 | 112.8 | 2.4 | 73.8 | 20.6 | −30.9 | 126.6 | 12.5 |
| | 90 | −36.5 | 42.4 | 125.4 | 14.5 | 111.9 | | 92.5 | 23.1 | −31.6 | 126.2 | 9.4 |
| | 125 | — | — | — | — | — | — | — | — | — | — | — |
| MV576^{f} | 0 | −29.0 | 46.3 | 128.9 | 7.7 | 112.9 | 2.0 | 78.3 | 15.6 | −27.5 | 126.6 | 8.8 |
| | 31 | −31.8 | 81.9 | 125.4 | 10.8 | 113.0 | 1.9 | 86.0 | 18.7 | −30.3 | 126.5 | 11.8 |
| | 90 | −34.7 | 42.6 | 125.2 | 13.5 | 112.4 | | 93.3 | 23.4 | −31.2 | 126.1 | 9.3 |
| | 125 | — | — | — | — | — | — | — | — | — | — | — |

^{a}MV570: PBAT | PBAT | PBAT | PBAT | PBAT;
^{b}MV573: PBAT | EFD rxn | EFD rxn | EFD rxn | PBAT;
^{c}MV574: PBAT | EFD rxn | Kaolin rxn | EFD rxn | PBAT; and
^{d}MV572: PBAT | EFD w/o rxn | Kaolin rxn | EFD w/o rxn | PBAT;
^{e}MV575: PBAT | MOF rxn | MOF rxn | MOF rxn | PBAT; PBAT | MOF rxn | MOF rxn | MOF rxn | PBAT;
^{f}MV576: PBAT | MOF rxn | kaolin rxn | MOF rxn | PBAT; Pronounced transitions are reported here.

TABLE 7
Degree of crystallinity, long-range periodic order, crystalline
and amorphous layer thickness as a function of biodegradation

| | Biodegradation | | | | |
|---|---|---|---|---|---|
| Film code | sampling day | X_{c} | Lₚ (nm) | I_{c} (nm) | Iₐ (nm) |
| MV570 | 0 | 0.08 | 10.47 | 0.40 | 10.06 |
| | 90 | 0.12 | 10.47 | 0.60 | 9.86 |
| MV573 | 0 | 0.09 | 10.47 | 0.45 | 10.02 |
| | 90 | 0.10 | 10.47 | 0.50 | 9.97 |
| MV574 | 0 | 0.08 | 10.47 | 0.42 | 10.04 |
| | 90 | 0.09 | 10.47 | 0.44 | 10.03 |
| MV572 | 0 | 0.08 | 10.47 | 0.39 | 10.07 |
| | 90 | 0.08 | 10.47 | 0.40 | 10.08 |

^{a} MV570: PBAT | PBAT | PBAT | PBAT | PBAT;
^{b} MV573: PBAT | EFD rxn | EFD rxn | EFD rxn | PBAT;
^{c} MV574: PBAT | EFD rxn | Kaolin rxn | EFD rxn | PBAT; and
^{d} MV572: PBAT | EFD w/o rxn | Kaolin rxn | EFD w/o rxn | PBAT

### REFERENCES

1. L K Ncube, A U Ude, E N Ogunmuyiwa, R Zulkifli, IN Bias. An overview of plastic waste generation and management in food packaging industries. Recycling, 2021, 6, Article no. 12.
2. High barrier films market for food packaging by material type (PE, BOPP & BOPET, CPP, EVOH, Nylon), technology, application (meat and fish, dairy, snacks, confectionery, bakery products, pet food), end user, and geography—Global Forecast to 2028. Report ID:MRCHM—104402. 2021. https://www.meticulousresearch.com/product/high-barrier-filrns-rnarket-5100. Downloaded on Jul. 7, 2007.
3. Ready meal trays market analysis report by type (portioned, perforated trays), by capacity (Upto 250 gms, 250-500 gms, more than 500 gms), by material (Polypropylene, CPET, Aluminum, Other Materials (HDPE, HIPS, etc.)), by end use, by region—global market insights 2019 to 2027. https://www.factmr.com/report/4189/readv˜rnealtravs-market. Downloaded on Jul. 7, 2007.
4. AR de Matos Costa, A Crocitti, LH de Carvalho, SC Carrocccio, P Cerruti, G Santagata. Properties of biodegradable films based on poly(butylene succinate) (PBS) and poly(butylene adipate-co-terephthalate) (PBAT) blends. Polymers, 2020, 12, Article ID 2317.
5. AK Pal, F Wu, M Mishra, AK Mohanty. Reactive extrusion of sustainable PHBV/PBAT-based nanocomposite films with organically modified nanoclay for packaging applications: Compression moulding vs. cast film extrusion. Compos Part B 2020, 198, Article ID 108141.
6. GAM Falcao, MBC Vitorino, TG Almeida, MAG Bardi, LH Carvalho, E L Canedo. PBAT/organoclay composite films: preparation and properties. Polym Bull, 2017, 74, 4423-4436.
7. P-G Ren, X-H Liu, F Ren, G-J Zhong, X Ji, L Xu. Biodegradable graphene oxide nanosheets/poly-(butylene adipate-co terephthalate) nanocomposite film with enhanced gas and water vapor barrier properties. Polym Test 2017, 58, 173-180.
8. CC Chang, BM Trinh, TH Mekonnen. Robust multiphase and multilayer starch/polymer (TPS/PBAT) film with simultaneous oxygen/moisture barrier properties J Colloid Interface Sci, 2021, 593, 290-303.
9. JA Stagner, VD Alves, R Narayan. Application and performance of maleated thermoplastic starch-poly(butylene adipate-co-terephthalate) blends for films. J Appl Polym Sci, 2012, 126, Article ID E135-E142.
10. R Venkatesan, N Rajeswari. TiO2 nanoparticles/poly(butylene adipate-coterephthalate) bionanocomposite films for packaging applications. Polym Adv Technol, 2017, 28, 20-27.
11. P Threepopnatkul, K Wongsuton, C Jaiaue, N Rakkietwinai, C Kulsetthanchalee. Thermal and barrier properties of poly(butylene adipate-coterephthalate) incorporated with zeolite doped potassium ion for packaging film. Mater Sci and Eng, 2020, 773, Article ID 012042.
12. J Zhang, C Cao, S Zheng, W Li, X Xie. Poly (butylene adipate-coterephthalate)/magnesium oxide/silver ternary composite biofilms for food packaging application. Food Packaging and Shelf Life, 2020, 24, Article ID 100487.
13. R Venkatesan, N Rajeswari. Preparation, mechanical and antimicrobial properties of SiO2/poly(butylene adipate-co-terephthalate) films for active food packaging. Silicon, 2019, 11, 2233-2239.
14. R Venkatesan, N Rajeswari, A Tamilselvi. Antimicrobial, mechanical, barrier, and thermal properties of bio-based poly (butylene adipate-co-terephthalate) (PBAT)/Ag20 nanocomposite films for packaging application. Polym Adv Technol, 2018, 29, 61-68.
15. AK Mohanty, W Feng, M Misra, A Pal, A Rodriguez-Wribe, T Wang. Compostable oxygen barrier comprising a biodegradable polymer matrix and biocarbon. WO 2021/226722 A1, 2021.
16. AK Mohanty, Y Parulekar, M Chidambarakumar, N Kositruangchai, BR Harte, Biodegradable polymeric nanocomposite compositions particularly for packaging. U.S. Pat. No. 7,619,025 B2, 2009.
17. MJ Choi, MH Jeon, J Yoo, MA Ok, K Chung. Multilayer film. US 2012/0183779, 2012.
18. [symbol] . Intelligent antifogging moisturizing high-barrier storage and transportation preservative film, preparation and application. CN111937958A, 2020.
19. [symbol] . Preparation method of multilayer IL @MOF composite film. CN 110064311B, 2021.
20. D Nakayama, F Wu, AK Mohanty, S Hirai, M Misra. Biodegradable composites developed from PBAT/PLA binary blends and silk powder: compatibilization and performance evaluation. ACS Omega, 2018, 3, 12412-12421.
21. S Sinha Ray, J Bandyopadhyay, M Khoza, V Ojijo, MR Scriba. Isotactic propylene based composite. US 2018/0057642 A1.
22. A Niemoeller. Free-radical maleation of poly(butylene adipate-co-terephthalate) in supercritical carbon dioxide and its effect on the percolation and deformation mechanism of layered silicate nanocomposites. A Dissertation Presented to the Faculty of the Graduate school of the Missouri University of Science and Technology, 2012.
23. N Othman, H Ismail, M Mariatti. Effect of compatibilisers on mechanical and thermal properties of bentonite filled polypropylene composites. Polym Degrde Stability 2006, 91, 1761-1774.
24. K Saraphat, R Phaorung, U Saengsuk, S Hemsri. Biodegradable poly(butylene adipate-co-terephthalate)/wheat gluten blends: Effect of PBAT modification on morphological, mechanical and water adsorption properties. IOP Conf. Series: Mater Sci Eng, 2020, 773 Article ID 012059.
25. N Catia Bastioli, N Angelos Rallis. Biodegradable polyester preparation process thereof and products comprising said polyester. U.S. Pat. No. 8,541,109 B2, 2013.
26. K Fukushima, M-H Wu, S Bocchini, A Rasyida, M-C Yang. PBAT Based Nanocomposites for Medical and Industrial Applications in Mater. Sci. Eng. 2012, C32, 1331-1351.
27. T. T Santos, T. G Almeida, D. D. S Morais, F. D Maga\tilde{l}haes, R. M Guedes, E. L Canedo, L. H Carvalho. Efect of Fler Type on Properties of PBAT/Organoclay Nanocomposites in Polym. Bull. 2020, 77, 901-917.
28. A. M Falcao, T. G Almeida, M. A. G Bardi, L. H Carvalho, E. L Canedo. PBAT/Organoclay Composite Flms-Part 2: Efect of UV Aging on Permeability, Mechanical Properties and Biodegradation in Polym. Bull. 2019, 76, 291-301.
29. S Muniyasamy, M. M Reddy, M Misra, A Mohanty. Biodegradable Green Composites from Bioethanol co-product and Poly(butylene adipate-co-terephthalate) in Industrial Crops and Products 2013, 43, 812-819.
30. J Šerá, M Kadle ̌ cková, A Fayyazbakhsh, V Ku ̌ cabová, M Koutný. Occurrence and Analysis of Thermophilic Poly(butylene adipate-co-terephthalate)-Degrading Microorganisms in Temperate Zone Soils in Int. J. Mol. Sci. 2020, 21 Article ID 7857.
31. I. F Pinheiro, F. V Ferreira, D. H. S Souza, R. F Gouveia, R. F.; L. M. F Lona, A. R Morales, L. H. I Mei. Mechanical, Rheological and Degradation Properties of PBAT Nanocomposites Reinforced by Functionalized Cellulose Nanocrystals in Euro. Polym. J. 2017, 97, 356-365.
32. T Kijchavengkul, R Auras, M Rubino, S Selke, M Ngouajio, R Thomas Fernandez, R. Biodegradation and hydrolysis rate of aliphatic aromatic polyester in Polym. Deg. Stability. 2010, 95, 2641-2647.
33. S Mohanty, S. K Nayak. Biodegradable Nanocomposites of Poly (butylene adipate-co-terephthalate) (PBAT) with Organically Modified Nanoclays in Int J. Plast. Technol. 2010, 14, 192-212.
34. P. M. S Souza, F. M Coelho, L. R. D Sommaggio, M. A Marin Morales, A. R Morales. Disintegration and Biodegradation in Soil of PBAT Mulch Films: Infuence of the Stabilization Systems Based on Carbon Black/Hindered Amine Light Stabilizer and Carbon Black/Vitamin E in J. Polym. Envioron. 2019, 27, 1584-1594.
35. T Kijchavengkul, R Auras, R. Perspective Compostability of polymers in Polym. Int. 2008, 57, 793-804.
36. G. A. M Falca6, M. B. C Vitorino, T. G Almeida, M. A. G Bardi, L. H Carvalho, E. L Canedo. PBAT/Organoclay Composite films: Preparation and Properties in Polym. Bull. 2017, 74, 4423-4436.
37. Y Fu, G Wu, X Bian, J Zeng, Y Weng. Biodegradation Behavior of Poly(Butylene Adipate-Co-Terephthalate) (PBAT), Poly(Lactic Acid) (PLA), and Their Blend in Freshwater with Sediment in Molecules. 2020, 25, Article ID 3946.
38. Q Deshoulles, M Le Gall, C Benali, J-M Raquez, C Dreanno, M Arhant, D Priour, S Cerantola, G Stoclet, P. Y Le Gac. Hydrolytic Degradation of Biodegradable Poly(butylene adipate-co-terephthalate) (PBAT)—Towards an Understanding of Microplastics Fragmentation in Polym. Degrad. Stab. 2022, 205, Article ID 110122.
39. L Li, Y Ji, Q Zhang, H Zhao, S Ali, P Chen, W Chen. Structural Evolution and Phase Transition of Uniaxially Stretched Poly(butylene-adipate-co-butylene terephthalate) Films as Revealed by in situ Synchotron Radiation Small and Wide Angle X-ray Scattering in Cryst. Eng. Comm. 2019, 21, 118-127.
40. G Zehetmeyer, S. M. M Meira, J. M Scheibel, R. V. B de Oliveira, A. Brandelli, R. M. D Soares. Influence of melt processing on biodegradable nisin-PBAT films intended for active food packaging applications in J. Appl. Polym. Sci. 2016, Article ID 43212.
41. S Girdthep, P Worajittiphon, T Leejarkpai, R Molloy, W Punyodom. Effect of silver-loaded kaolinite on real ageing, hydrolytic degradation, and biodegradation of composite blown films based on poly(lactic acid) and poly(butylene adipate-co-terephthalate) in Euro. Polym. J. 2016, 82, 244-259.

1. A preparation method of biodegradable polymer nanocomposite films with superior gas barrier and tensile properties and dimensional stability at a retort temperature, comprising:
providing a biodegradable polymer, wherein the biodegradable polymer is an aliphatic-aromatic copolyester based on the monomers 1.4-butanediol, adipic acid, terephthalic acid, succinic acid, and lactic acid in the polymer chain;
providing a concentration of nanoparticles, the nanoparticles including layered silicate type nanoclay and Metal Organic Framework (MOF);
providing an organic linker, wherein the organic linker is fumaric acid; and
utilizing a one-step-reactive compounding method to achieve improved interaction between the biodegradable polymer and the nanoparticles, leading to enhanced dispersion and distribution of the nanoparticles in the nanocomposite films.

2. The preparation method of biodegradable polymer nanocomposite films of claim 1, wherein the concentration of nanoparticles ranges between 1 to 10 wt %.

3. The preparation method of biodegradable polymer nanocomposite films of claim 2, wherein the concentration of nanoparticles is below 5 wt %.

4. The preparation method of biodegradable polymer nanocomposite films of claim 1, wherein the one-step-reactive compounding method relates to a reactive extrusion process.

5. The preparation method of biodegradable polymer nanocomposite films of claim 4, wherein the reactive extrusion process comprises co-rotating twin screw extrusion of biodegradable polymer and nanofillers in the presence of a free radical initiator.

6. The preparation method of biodegradable polymer nanocomposite films of claim 5, wherein the reactive extrusion process further includes the addition of a functional organic moiety to enhance wettability of nanoclay in the polymer.

7. The preparation method of biodegradable polymer nanocomposite films of claim 5, wherein the reactive extrusion process further includes the addition of a chain extender to minimize the reduction in molecular weight during processing.

8. The preparation method of biodegradable polymer nanocomposite films of claim 5, wherein the reactive extrusion process further includes the presence of an antioxidant to improve processing stability.

9. The preparation method of biodegradable polymer nanocomposite films of claim 8, wherein the free radical initiator is dicumyl peroxide in the range of 0.2 to 0.5 wt %.

10. The preparation method of biodegradable polymer nanocomposite films of claim 6, wherein the functional organic moiety is maleic anhydride in the range of 1 to 6 wt %.

11. The preparation method of biodegradable polymer nanocomposite films of claim 6, wherein the functional organic moiety is maleic anhydride in the range of 1.9 wt %.

12. The preparation method of biodegradable polymer nanocomposite films of claim 1, wherein the nanocomposites films are processed using a temperature profile of 120| 130| 140|145|130|120|110|110|110|110° C., screw speed between 80 and 200 rpm, and feed rate of 1 to 15 kg per hour.

13. The preparation method of biodegradable polymer nanocomposite films of claim 12, wherein the screw speed is preferably 116 rpm.

14. The preparation method of biodegradable polymer nanocomposite films of claim 12, wherein the feed rate is preferably 6.6 kg/h.

15. The preparation method of biodegradable polymer nanocomposite films of claim 4, wherein the reactive extrudate process is collected through water bath or air.

16. A biodegradable polymer nanocomposite film obtained from the preparation method as described in claim 1, wherein the nanocomposite film comprises polybutylene adipate-co-terephthalate (PBAT) nanocomposite as a central layer and a biodegradable polymer of a specific choice as the supportive outer layers.

17. The biodegradable polymer nanocomposite film of claim 16, wherein the biodegradable polymer of a specific choice for the supportive outer layers is polybutylene succinate (PBS).

18. The preparation method of biodegradable polymer nanocomposite films of claim 15, wherein the reactive extrudate process is collected through air prior to pelletization into pellets that are subsequently dried at 70° C. for 16 h and used to prepare multi layered nanocomposite films.
